(19) United States
(12) Patent Application Publication
(10) Pub. No.: US 2023/0354270 A1
(43) Pub. Date: Nov. 2, 2023

(54) METHOD AND APPARATUS FOR COEXISTENCE BETWEEN LONG TERM EVOLUTION SIDELINK AND NEW RADIO SIDELINK

(71) Applicant: ELECTRONICS AND TELECOMMUNICATIONS RESEARCH INSTITUTE, Daejeon (KR)

(72) Inventors: Jung Hoon LEE, Daejeon (KR); Cheul Soon KIM, Daejeon (KR); Sung Hyun MOON, Daejeon (KR)

(73) Assignee: ELECTRONICS AND TELECOMMUNICATIONS RESEARCH INSTITUTE, Daejeon (KR)

(21) Appl. No.: 18/305,711

(22) Filed: Apr. 24, 2023

(30) Foreign Application Priority Data
Apr. 27, 2022 (KR) 10-2022-0052269
Aug. 12, 2022 (KR) 10-2022-0101148
Sep. 30, 2022 (KR) 10-2022-0125311
Nov. 7, 2022 (KR) 10-2022-0147075
Feb. 6, 2023 (KR) 10-2023-0015670
Feb. 17, 2023 (KR) 10-2023-0021646
Apr. 18, 2023 (KR) 10-2023-0050417

(51) Int. Cl. H04W 72/02; H04W 28/26; H04B 17/318

(52) U.S. Cl. CPC H04W 72/02; H04W 28/26; H04B 17/328

(57) ABSTRACT

A method of a first terminal supporting a first radio access technology (RAT) and a second RAT may comprise: determining candidate resources by performing a resource sensing operation based on the first RAT; performing a resource selection operation based on the first RAT with respect to the candidate resources in consideration of information on resources of the second RAT; and performing sidelink (SL) communication based on the first RAT with a second terminal using resources selected by the resource selection operation based on the first RAT.

### CROSS-REFERENCE TO RELATED APPLICATIONS

This application claims priority to Korean Patent Applications No. 10-2022-0052269, filed on Apr. 27, 2022, No. 10-2022-0101148, filed on Aug. 12, 2022, No. 10-2022-0125311, filed on Sep. 30, 2022, No. 10-2022-0147075, filed on Nov. 7, 2022, No. 10-2023-0015670, filed on Feb. 6, 2023, No. 10-2023-0021646, filed on Feb. 17, 2023, and No. 10-2023-0050417, filed on Apr. 18, 2023, with the Korean Intellectual Property Office (KIPO), the entire contents of which are hereby incorporated by reference.

### BACKGROUND

### 1. Technical Field

Exemplary embodiments of the present disclosure relate to a sidelink (SL) communication technique and more particularly, to a technique for coexistence between a long term evolution (LTE) sidelink and a new radio (NR) sidelink.

### 2. Related Art

The communication system (e.g., a new radio (NR) communication system) using a higher frequency band (e.g., a frequency band of 6 GHz or above) than a frequency band (e.g., a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

Meanwhile, the LTE communication system and the NR communication system may support sidelink (SL) communication. LTE SL communication and NR SL communication may be performed in the same resources. In this case, a collision between the LTE SL communication and the NR SL communication may occur. Techniques for coexistence between the LTE SL communication and NR the SL communication in the same resources (e.g., the same channel) are needed.

### SUMMARY

Exemplary embodiments of the present disclosure are directed to providing a method and an apparatus for coexistence between LTE SL communication and NR SL communication.

According to a first exemplary embodiment of the present disclosure, a method of a first terminal supporting a first radio access technology (RAT) and a second RAT may comprise: determining candidate resources by performing a resource sensing operation based on the first RAT; performing a resource selection operation based on the first RAT with respect to the candidate resources in consideration of information on resources of the second RAT; and performing sidelink (SL) communication based on the first RAT with a second terminal using resources selected by the resource selection operation based on the first RAT.

When resource sharing between the first RAT and the second RAT is configured, the information on the resources of the second RAT may be shared for the resource selection operation based on the first RAT, the first RAT may be a new radio (NR) communication technology, and the second RAT may be a long term evolution (LTE) communication technology.

The information on the resources of the second RAT may indicate one or more resources reserved by a third terminal supporting the second RAT, and at least one candidate resource overlapping with the one or more reserved resources among the candidate resources may be excluded in the resource selection operation based on the first RAT.

When the information on the resources of the second RAT indicates one or more resources reserved by a third terminal supporting the second RAT, and a reference signal received power (RSRP) of at least one reserved resource among the one or more reserved resources is greater than or equal to an RSRP threshold, at least one candidate resource overlapping with the at least one reserved resource among the candidate resources may be excluded in the resource selection operation based on the first RAT.

The information on the resources of the second RAT may include at least one of information on a time resource reserved by a third terminal, information on a frequency resource reserved by the third terminal, information on a periodicity of a resource reserved by the third terminal, information on an RSRP for the reserved resource, information on a priority of data of the third terminal, or combinations thereof.

The RSRP threshold may be configured by system information, PC5-radio resource control (RRC) signaling, or user equipment (UE)-specific RRC signaling.

When a first subcarrier spacing (SCS) applied to the first RAT is different from a second SCS applied to the second RAT, the selected resources may include all slots overlapping duration corresponding to SL transmission based on the second RAT, and SL communication based on the first RAT may be continuously performed over the all slots.

When a first subcarrier spacing (SCS) applied to the first RAT is different from a second SCS applied to the second RAT, the selected resources may include a first slot overlapping duration corresponding to SL transmission based on the second RAT, and SL communication based on the first RAT may be allowed in the first slot.

When physical sidelink feedback channel (PSFCH) transmission based on the first RAT overlaps SL transmission based on the second RAT in SL transmission based on the first RAT, which is performed between the first terminal and the second terminal, the PSFCH transmission based on the first RAT may be dropped or disabled.

The performing of the resource selection operation based on the first RAT may comprise: when PSFCH transmission based on the first RAT overlaps SL transmission based on the second RAT, excluding at least one candidate resource for transmission of a physical sidelink shared channel (PSSCH) associated with the PSFCH transmission based on the first RAT among the candidate resources.

According to a second exemplary embodiment of the present disclosure, a first terminal supporting a first radio access technology (RAT) and a second RAT may comprise a processor, and the processor may cause the first terminal to perform: determining candidate resources by performing a resource sensing operation based on the first RAT; performing a resource selection operation based on the first RAT with respect to the candidate resources in consideration of information on resources of the second RAT; and performing sidelink (SL) communication based on the first RAT with a second terminal using resources selected by the resource selection operation based on the first RAT.

When resource sharing between the first RAT and the second RAT is configured, the information on the resources of the second RAT may be shared for the resource selection operation based on the first RAT, the first RAT may be a new radio (NR) communication technology, and the second RAT may be a long term evolution (LTE) communication technology.

The information on the resources of the second RAT may indicate one or more resources reserved by a third terminal supporting the second RAT, and at least one candidate resource overlapping with the one or more reserved resources among the candidate resources may be excluded in the resource selection operation based on the first RAT.

When the information on the resources of the second RAT indicates one or more resources reserved by a third terminal supporting the second RAT, and a reference signal received power (RSRP) of at least one reserved resource among the one or more reserved resources is greater than or equal to an RSRP threshold, at least one candidate resource overlapping with the at least one reserved resource among the candidate resources may be excluded in the resource selection operation based on the first RAT.

The information on the resources of the second RAT may include at least one of information on a time resource reserved by a third terminal, information on a frequency resource reserved by the third terminal, information on a periodicity of a resource reserved by the third terminal, information on an RSRP for the reserved resource, information on a priority of data of the third terminal, or combinations thereof.

The RSRP threshold may be configured by system information, PC5-radio resource control (RRC) signaling, or user equipment (UE)-specific RRC signaling.

When a first subcarrier spacing (SCS) applied to the first RAT is different from a second SCS applied to the second RAT, the selected resources may include all slots overlapping duration corresponding to SL transmission based on the second RAT, and SL communication based on the first RAT may be continuously performed over the all slots.

When a first subcarrier spacing (SCS) applied to the first RAT is different from a second SCS applied to the second RAT, the selected resources may include a first slot overlapping duration corresponding to SL transmission based on the second RAT, and SL communication based on the first RAT may be allowed in the first slot.

When physical sidelink feedback channel (PSFCH) transmission based on the first RAT overlaps SL transmission based on the second RAT in SL transmission based on the first RAT, which is performed between the first terminal and the second terminal, the PSFCH transmission based on the first RAT may be dropped or disabled.

In the performing of the resource selection operation based on the first RAT, the processor may further cause the first terminal to perform: when PSFCH transmission based on the first RAT overlaps SL transmission based on the second RAT, excluding at least one candidate resource for transmission of a physical sidelink shared channel (PSSCH) associated with the PSFCH transmission based on the first RAT among the candidate resources.

According to the present disclosure, a terminal may determine candidate resources by performing an NR SL resource sensing operation, and may perform an NR SL resource selection operation in consideration of LTE resource information. According to the above-described operation, when NR SL communication and LTE SL communication coexist in the same resources, the NR SL communication can be performed in resources selected in consideration of the LTE resource information. Accordingly, a collision between the NR SL communication and the LTE SL communication can be prevented, efficiency of resource use can be improved, and performance of the communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a type 1 frame.

FIG. 4 is a conceptual diagram illustrating a first exemplary embodiment of a type 2 frame.

FIG. 5 is a conceptual diagram illustrating a first exemplary embodiment of a transmission method of SS/PBCH block in a communication system.

FIG. 6 is a conceptual diagram illustrating a first exemplary embodiment of an SS/PBCH block in a communication system.

FIG. 7 is a conceptual diagram illustrating a second exemplary embodiment of a method of transmitting SS/PBCH blocks in a communication system.

FIG. 8 is a conceptual diagram illustrating a first exemplary embodiment of SSB burst configuration.

FIG. 9A is a conceptual diagram illustrating an RMSI CORESET mapping pattern #1 in a communication system.

FIG. 9B is a conceptual diagram illustrating an RMSI CORESET mapping pattern #2 in a communication system.

FIG. 9C is a conceptual diagram illustrating an RMSI CORESET mapping pattern #3 in a communication system.

FIG. 10 is a conceptual diagram illustrating a first exemplary embodiment of configuration of a slot in which a PSFCH is configured.

FIG. 11 is a conceptual diagram illustrating a first exemplary embodiment of a PSFCH for ACK/NACK transmission.

FIG. 12 is a conceptual diagram illustrating exemplary embodiments of a method for multiplexing a control channel and a data channel in sidelink communication.

FIG. 13 is a conceptual diagram illustrating a first exemplary embodiment of a resource selection operation.

FIG. 14 is a conceptual diagram illustrating a first exemplary embodiment of a resource reselection operation.

FIG. 15A is a conceptual diagram illustrating a first exemplary embodiment of a method of configuring a PSCCH resource and a PSSCH resource to be contiguous.

FIG. 15B is a conceptual diagram illustrating a first exemplary embodiment of a method of configuring a PSCCH resource and a PSSCH resource to be non-contiguous.

FIG. 16 is a conceptual diagram illustrating an example in which resource grids are not aligned between LTE SL and NR SL.

FIG. 17 is a conceptual diagram illustrating a first exemplary embodiment of NR transmission using different transmit powers.

FIG. 18A is a conceptual diagram illustrating a first exemplary embodiment of PSFCH resource allocation.

FIG. 18B is a conceptual diagram illustrating a second exemplary embodiment of PSFCH resource allocation.

FIG. 19 is a conceptual diagram illustrating a first exemplary embodiment of a timeline for delivering LTE sensing information to an NR SL module.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

Hereinafter, even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

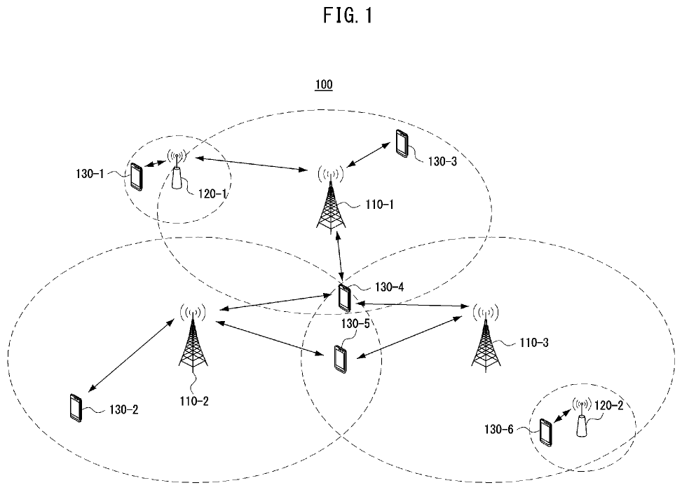

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

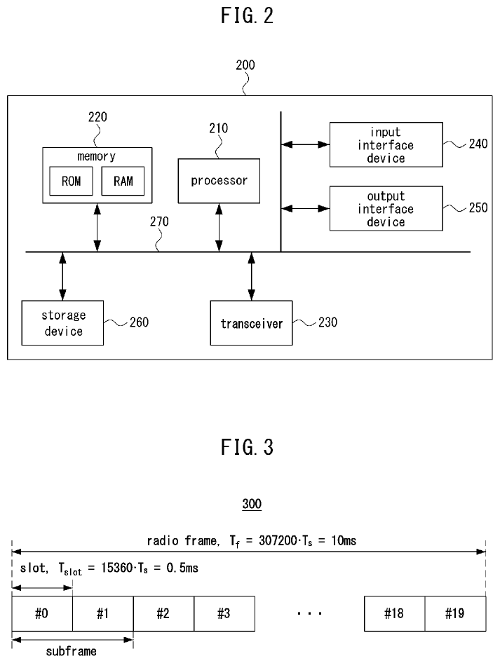

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

FIG. 3 is a conceptual diagram illustrating a first exemplary embodiment of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, . . . , slot #18, and slot #19). The length T_{f} of the radio frame 300 may be 10 milliseconds (ms). The length of the subframe may be 1 ms, and the length Tₛₗₒₜ of a slot may be 0.5 ms. Here, Tₛ may indicate a sampling time, and may be 1/30,720,000 s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

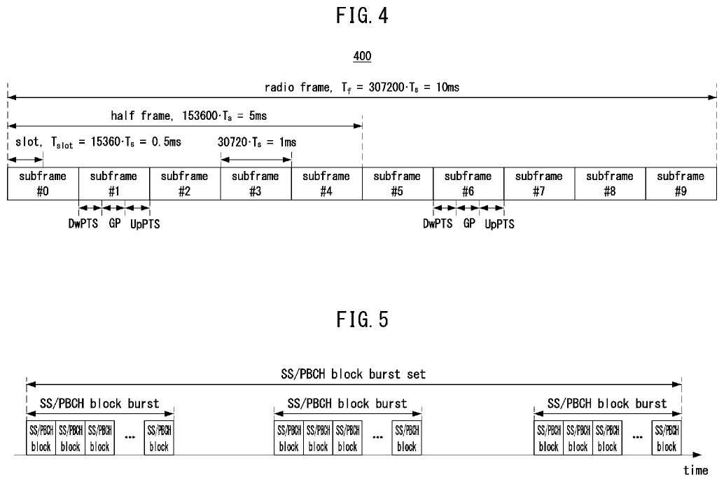

FIG. 4 is a conceptual diagram illustrating a first exemplary embodiment of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000 s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the gold sequence generated by being initialized by the cell ID. Thereafter, the gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

On the other hand, the communication system may support not only a high transmission rate but also technical requirements for various service scenarios. For example, the communication system may support an enhanced mobile broadband (eMBB) service, an ultra-reliable low-latency communication (URLLC) service, a massive machine type communication (mMTC) service, and the like.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

The communication system may support numerologies defined in Table 1 below.

TABLE 1

| Numerology (μ) | 0 | 1 | 2 | 3 | 4 | 5 |
|---|---|---|---|---|---|---|
| Subcarrier | 15 kHz | 30 kHz | 60 kHz | 120 kHz | 240 kHz | 480 kHz |
| spacing | | | | | | |
| OFDM symbol | 66.7 | 33.3 | 16.7 | 8.3 | 4.2 | 2.1 |
| length [us] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support FR1 as well as FR2. The FR2 may be classified into FR2-1 and FR2-2. The FR1 may be a frequency band of 6 GHz or below, the FR2-1 may be a frequency band of 24.25 to 52.6, and the FR2-2 may be a frequency band of 52.6 to 71 GHz. In an exemplary embodiment, the FR2 may be the FR2-1, the FR2-1, or a frequency band including the FR2-1 and FR2-2. In each of the FR1, FR2-1, and FR2-2, subcarrier spacings available for data transmission may be defined as shown in Table 2 below. In each of the FR1, the FR2-1, and the FR2-2, SCSs available for synchronization signal block (SSB) transmission may be defined as shown in Table 3 below. In each of the FR1, the FR2-1, and the FR2-2, SCSs available for RACH transmission (e.g., Msg1 or Msg-A) may be defined as shown in Table 4 below.

TABLE 2
data

| FR1 | FR2-1 | FR2-2 |
|---|---|---|
| 15 kHz, 30 kHz, | 60 kHz, 120 kHz | 120 kHz, 480 kHz, |
| 60 kHz (optional) | | 960 kHz |

TABLE 3
SSB

| FR1 | FR2-1 | FR2-2 |
|---|---|---|
| 15 kHz, 30 kHz | 120 kHz, 240 kHz | 120 kHz, 480 kHz, |
| | | 960 kHz |

TABLE 4
RACH

| FR1 | FR2-1 | FR2-2 |
|---|---|---|
| 1.25 kHz, 5 kHz, | 60 kHz, 120 kHz | 120 kHz, 480 kHz, |
| 15 kHz, 30 kHz | | 960 kHz |

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beam forming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In this case, the common control channels and the common signals for all terminals belonging to the cell coverage may be transmitted based on a beam sweeping scheme.

In addition, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

FIG. 5 is a conceptual diagram illustrating a first exemplary embodiment of a transmission method of SS/PBCH block in a communication system.

Referring to FIG. 5, one or more SS/PBCH blocks may be transmitted in a beam sweeping scheme within an SS/PBCH block burst set. Up to L SS/PBCH blocks may be transmitted within one SS/PBCH block burst set. L may be an integer equal to or greater than 2, and may be defined in the 3GPP standard. Depending on a region of a system frequency, L may vary. Within the SS/PBCH block burst set, the SS/PBCH blocks may be located consecutively or distributedly. The consecutive SS/PBCH blocks may be referred to as an ‘SS/PBCH block burst’. The SS/PBCH block burst set may be repeated periodically, and system information (e.g., MIB) transmitted through the PBCHs of the SS/PBCH blocks within the SS/PBCH block burst set may be the same. An index of the SS/PBCH block, an index of the SS/PBCH block burst, an index of an OFDM symbol, an index of a slot, and the like may be indicated explicitly or implicitly by the PBCH.

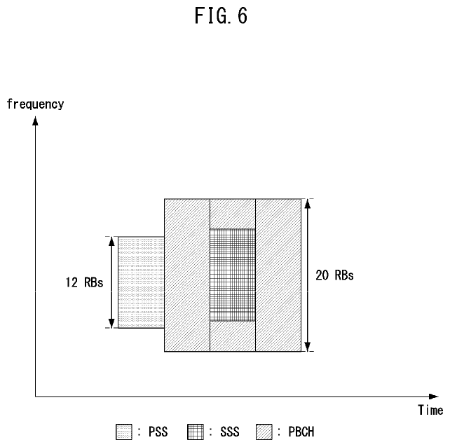

FIG. 6 is a conceptual diagram illustrating a first exemplary embodiment of an SS/PBCH block in a communication system.

Referring to FIG. 6, signals and a channel are arranged within one SS/PBCH block in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. That is, the PBCH may be transmitted in both end bands adjacent to the frequency band in which the SSS is transmitted. When the maximum number of SS/PBCH blocks is 8 in the sub 6 GHz frequency band, an SS/PBCH block index may be identified based on a demodulation reference signal used for demodulating the PBCH (hereinafter, referred to as ‘PBCH DMRS’). When the maximum number of SSBs is 64 in the over 6 GHz frequency band, LSB 3 bits of 6 bits representing the SS/PBCH block index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SS/PBCH blocks may be multiplexed in the frequency domain within the system bandwidth of the NR system supporting a wide band. In this case, the SS/PBCH blocks may be transmitted as follows.

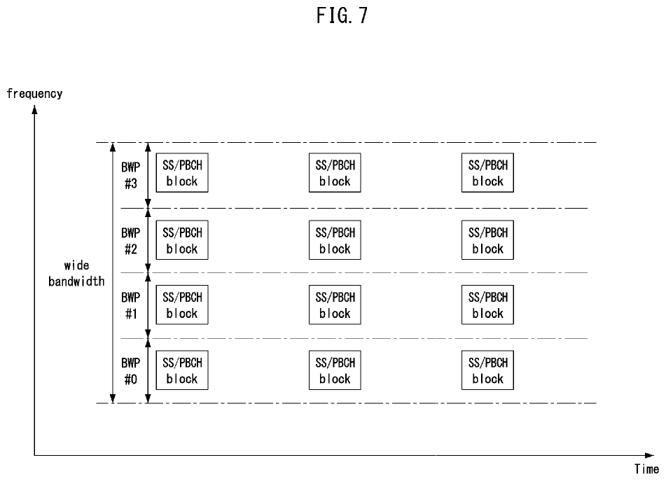

FIG. 7 is a conceptual diagram illustrating a second exemplary embodiment of a method of transmitting SS/PBCH blocks in a communication system.

Referring to FIG. 7, a wideband component carrier (CC) may include a plurality of bandwidth parts (BWPs). For example, the wideband CC may include 4 BWPs. The base station may transmit SS/PBCH blocks in the respective BWPs #0 to #3 belonging to the wideband CC. The terminal may receive the SS/PBCH block(s) from one or more BWPs of the BWPs #0 to #3, and may perform an initial access procedure using the received SS/PBCH block.

After detecting the SS/PBCH block, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SS/PBCH block. A plurality of SS/PBCH blocks may be transmitted in the entire system band, and one or more SS/PBCH blocks among the plurality of SS/PBCH blocks may be SS/PBCH block(s) associated with the RMSI. The remaining SS/PBCH blocks may not be associated with the RMSI. The SS/PBCH block associated with the RMSI may be defined as a ‘cell defining SS/PBCH block’. The terminal may perform a cell search procedure and an initial access procedure by using the cell-defining SS/PBCH block. The SS/PBCH block not associated with the RMSI may be used for a synchronization procedure and/or a measurement procedure in the corresponding BWP. The BWP(s) through which the SS/PBCH block is transmitted may be limited to one or more BWPs within a wide bandwidth.

The positions at which the SSBs are transmitted in the time domain may be defined differently according to an SCS and a value of L. In exemplary embodiments, the SCS may mean a subcarrier size. The SSB may be transmitted in some symbols within one slot, and a short UL transmission (e.g., uplink control information (UCI) transmission) may be performed in the remaining symbols not used for the SSB transmission within one slot. When the SSB is transmitted in radio resources to which a large SCS (e.g., 120 kHz SCS or 240 kHz SCS) is applied, a gap may be configured in the middle of consecutive slots including the SSB so that a long UL transmission (e.g., transmission of URLLC traffic) can be performed at least every 1 ms.

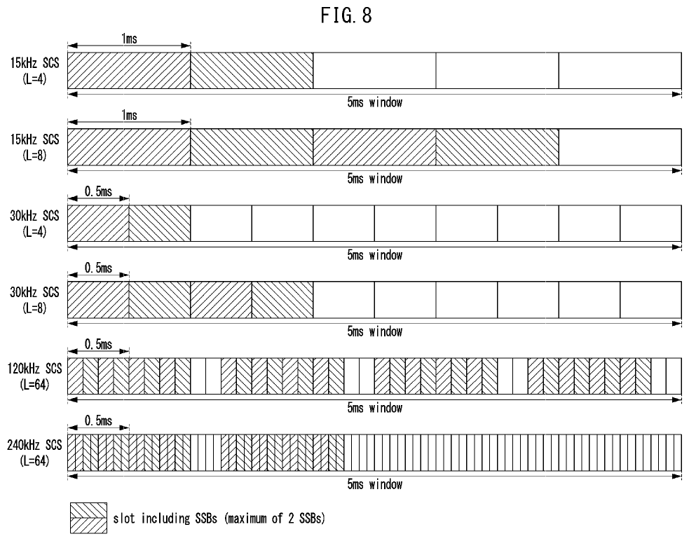

FIG. 8 is a conceptual diagram illustrating a first exemplary embodiment of SSB burst configuration.

Referring to FIG. 8, in a transmission procedure of SSBs (e.g., SSB burst) in radio resources to which a 120 kHz SCS is applied, the base station may transmit SSBs in 8 consecutive slots. In a transmission procedure of SSBs in radio resources to which s 240 kHz SCS is applied, the base station may transmit SSBs in 16 consecutive slots. In the radio resources to which the 120 kHz SCS or 240 kHz SCS is applied, a gap for UL transmission may be configured.

The RMSI may be obtained by performing an operation to obtain configuration information of a CORESET from the SS/PBCH block (e.g., PBCH), an operation of detecting a PDCCH based on the configuration information of the CORESET, an operation to obtain scheduling information of a PDSCH from the PDCCH, and an operation to receive the RMSI on the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

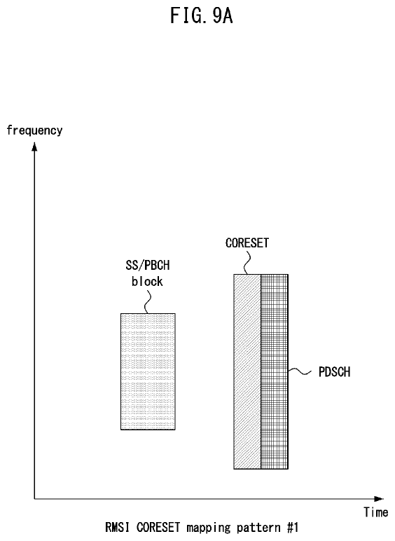

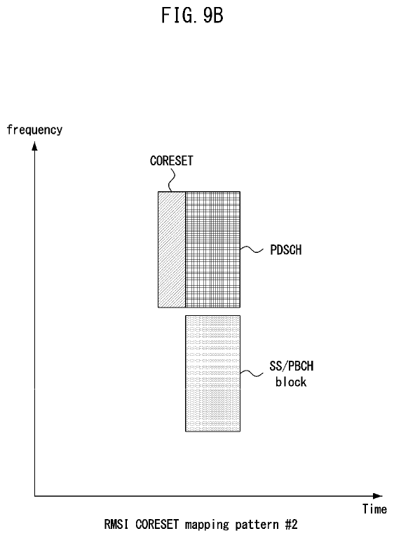

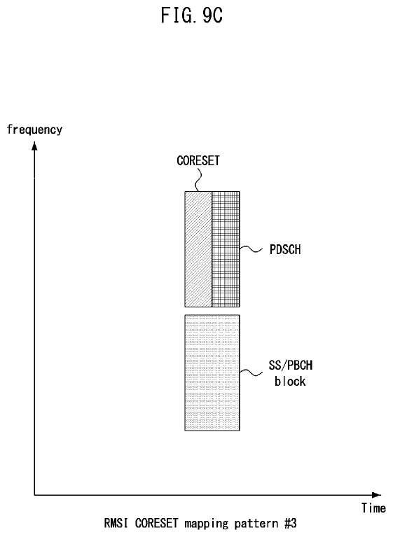

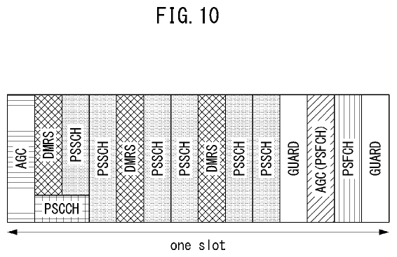

FIG. 9A is a conceptual diagram illustrating an RMSI CORESET mapping pattern #1 in a communication system, FIG. 9B is a conceptual diagram illustrating an RMSI CORESET mapping pattern #2 in a communication system, and FIG. 9C is a conceptual diagram illustrating an RMSI CORESET mapping pattern #3 in a communication system.

Referring to FIGS. 9A to 9C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

In the NR system, a PDSCH may be mapped to the time domain according to a PDSCH mapping type A or a PDSCH mapping type B. The PDSCH mapping types A and B may be defined as Table 5 below.

TABLE 5
PDSCH

| mapping | Normal CP | | | Extended CP | | |
|---|---|---|---|---|---|---|
| type | S | L | S + L | S | L | S + L |
| Type A | {0, 1, 2, 3} | {3, . . . , 14} | {3, . . . , 14} | {0, 1, 2, 3} | {3, . . . , 12} | {3, . . . , 12} |
| | (Note 1) | | | (Note 1) | | |
| Type B | {0, . . . , 12} | {2, 4, 7} | {2, . . . , 14} | {0, . . . , 10} | {2, 4, 6} | {2, . . . , 12} |

(Note 1):
S = 3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of {2, 4, 7} within a range not exceeding a slot boundary. A DMRS (hereinafter, referred to as ‘PDSCH DMRS’) for demodulation of the PDSCH (e.g., data) may be determined by the PDSCH mapping type (e.g., type A or type B) and an ID indicating the length. The ID may be defined differently according to the PDSCH mapping type.

Meanwhile, NR-unlicensed (NR-U) is being discussed in the NR standardization meeting. The NR-U system may increase network capacity by improving the utilization of limited frequency resources. The NR-U system may support operation in an unlicensed band (e.g., unlicensed spectrum).

In the NR-U system, the terminal may determine whether a signal is transmitted from a base station based on a discovery reference signal (DRS) received from the corresponding base station in the same manner as in the general NR system. In the NR-U system in a Stand-Alone (SA) mode, the terminal may acquire synchronization and/or system information based on the DRS. In the NR-U system, the DRS may be transmitted according to a regulation of the unlicensed band (e.g., transmission band, transmit power, transmission time, etc.). For example, according to Occupied Channel Bandwidth (OCB) regulations, signals may be configured and/or transmitted to occupy 80% of the total channel bandwidth (e.g., 20 MHz).

In the NR-U system, a communication node (e.g., base station, terminal) may perform a Listen Before Talk (LBT) procedure before transmitting a signal and/or a channel for coexistence with another system. The signal may be a synchronization signal, a reference signal (e.g., DRS, DMRS, channel state information (CSI)-RS, phase tracking (PT)-RS, sounding reference signal (SRS)), or the like. The channel may be a downlink channel, an uplink channel, a sidelink channel, or the like. In exemplary embodiments, a signal may mean the ‘signal’, the ‘channel’, or the ‘signal and channel’. The LBT procedure may be an operation for checking whether a signal is transmitted by another communication node. If it is determined by the LBT procedure that there is no transmission signal (e.g., when the LBT procedure is successful), the communication node may transmit a signal in the unlicensed band. If it is determined by the LBT procedure that a transmission signal exists (e.g., when the LBT fails), the communication node may not be able to transmit a signal in the unlicensed band. The communication node may perform a LBT procedure according to one of various categories before transmission of a signal. The category of LBT may vary depending on the type of the transmission signal.

Meanwhile, NR vehicle-to-everything (V2X) communication technology is being discussed in the NR standardization meeting. The NR V2X communication technology may be a technology that supports communication between vehicles, communication between a vehicle and an infrastructure, communication between a vehicle and a pedestrian, and the like based on device-to-device (D2D) communication technologies. Techniques for reducing power consumption and improving reliability are being discussed for NR V2C communication.

The NR V2X communication (e.g., sidelink communication) may be performed according to three transmission schemes (e.g., unicast scheme, broadcast scheme, groupcast scheme). When the unicast scheme is used, a PC5-RRC connection may be established between a first terminal (e.g. transmitting terminal that transmits data) and a second terminal (e.g., receiving terminal that receives data), and the PC5-RRC connection may refer to a logical connection for a pair between a source ID of the first terminal and a destination ID of the second terminal. The first terminal may transmit data (e.g., sidelink data) to the second terminal. When the broadcast scheme is used, the first terminal may transmit data to all terminals. When the groupcast scheme is used, the first terminal may transmit data to a group (e.g., groupcast group) composed of a plurality of terminals.

When the unicast scheme is used, the second terminal may transmit feedback information (e.g., acknowledgment (ACK) or negative ACK (NACK)) to the first terminal in response to data received from the first terminal. In the exemplary embodiments below, the feedback information may be referred to as a ‘HARQ-ACK’, ‘feedback signal’, a ‘physical sidelink feedback channel (PSFCH) signal’, or the like. When ACK is received from the second terminal, the first terminal may determine that the data has been successfully received at the second terminal. When NACK is received from the second terminal, the first terminal may determine that the second terminal has failed to receive the data. In this case, the first terminal may transmit additional information to the second terminal based on an HARQ scheme. Alternatively, the first terminal may improve a reception probability of the data at the second terminal by retransmitting the same data to the second terminal.

When the broadcast scheme is used, a procedure for transmitting feedback information for data may not be performed. For example, system information may be transmitted in the broadcast scheme, and the terminal may not transmit feedback information for the system information to the base station. Therefore, the base station may not identify whether the system information has been successfully received at the terminal. To solve this problem, the base station may periodically broadcast the system information.

When the groupcast scheme is used, a procedure for transmitting feedback information for data may not be performed. For example, necessary information may be periodically transmitted in the groupcast scheme, without the procedure for transmitting feedback information. However, when the candidates of terminals participating in the groupcast scheme-based communication and/or the number of the terminals participating in that is limited, and the data transmitted in the groupcast scheme is data that should be received within a preconfigured time (e.g., data sensitive to delay), it may be necessary to transmit feedback information also in the groupcast sidelink communication. The groupcast sidelink communication may mean sidelink communication performed in the groupcast scheme. When the feedback information transmission procedure is performed in the groupcast sidelink communication, data can be transmitted and received efficiently and reliably.

In the groupcast sidelink communication, two HARQ-ACK feedback schemes (i.e., transmission procedures of feedback information) may be supported. When the number of receiving terminals in a sidelink group is large and a service scenario 1 is supported, some receiving terminals belonging to a specific range within the sidelink group may transmit NACK through a PSFCH when data reception fails. This scheme may be a groupcast HARQ-ACK feedback option 1. In the service scenario 1, instead of all the receiving terminals in the sidelink group, it may be allowed for some receiving terminals belonging to a specific range to perform reception in a best-effort manner. The service scenario 1 may be an extended sensor scenario in which some receiving terminals belonging to a specific range need to receive the same sensor information from a transmitting terminal. In exemplary embodiments, the transmitting terminal may refer to a terminal transmitting data, and the receiving terminal may refer to a terminal receiving data.

When the number of receiving terminals in the sidelink group is limited and a service scenario 2 is supported, each of all the receiving terminals belonging to the sidelink group may report HARQ-ACK for data individually through a separate PSFCH. This scheme may be a groupcast HARQ-ACK feedback option 2. In the service scenario 2, since PSFCH resources are sufficient, the transmitting terminal may perform monitoring on HARQ-ACK feedbacks of all the receiving terminals belonging to the sidelink group, and data reception may be guaranteed at all the receiving terminals belonging to the sidelink group.

As in broadcast sidelink communication, data may be transmitted and received without a HARQ-ACK feedback procedure in unicast sidelink communication and groupcast sidelink communication. In this case, in order to increase a probability of receiving the data, a transmitting terminal may retransmit the data a preset number of times.

In all transmission schemes (e.g., unicast transmission, groupcast transmission, and broadcast transmission), whether a HARQ-ACK feedback procedure is applied may be statically or semi-statically configured to the terminal(s) by signaling (e.g., system information signaling, PC5-RRC signaling, UE-specific RRC signaling, control information signaling). In sidelink communication, HARQ-ACK feedback information may be transmitted on a PSFCH. If reception of a PSSCH is successful, a receiving terminal may transmit ACK for the PSSCH (e.g., data) on the PSFCH. If reception of the PSSCH fails, the receiving terminal may transmit NACK for the PSSCH (e.g., data) on the PSFCH. The PSFCH may be a channel for reporting ACK/NACK information (e.g., HARQ-ACK feedback) to the transmitting terminal. A resource region (e.g., PSFCH resource region) for PSFCH transmission (e.g., transmission of HARQ-ACK feedback) may be preconfigured within a specific resource pool. The PSFCH (e.g., PSFCH resource or PSFH resource region) may be configured periodically. A PSFCH periodicity for the PSFCH resource may be k slots (e.g., logical sidelink (SL) slots). k may be a natural number. For example, k may be 1, 2, or 4.

FIG. 10 is a conceptual diagram illustrating a first exemplary embodiment of configuration of a slot in which a PSFCH is configured.

Referring to FIG. 10, a PSFCH (e.g., HARQ-ACK feedback) may be repeatedly transmitted in two symbols (e.g., two OFDM symbols) within a slot (e.g., SL slot). The first symbol among two symbols in which the PSFCH is transmitted may be used for automatic gain control (AGC) for correct PSFCH receive power level adjustment.

The PSFCH may be transmitted within a frequency resource region preconfigured by system information. In this case, the frequency resource region for PSFCH transmission may be indicated (e.g., signaled) in form of a bitmap within the resource pool. The receiving terminal may implicitly select a location of the frequency resource region for PSFCH transmission based on indexes of a slot and a subchannel in which a PSSCH is received. The receiving terminal may identify the number of resource blocks (RBs) and the number of PSFCH resources multiplexable based on cyclic shifts of a PSFCH sequence within the frequency resource region. The receiving terminal may implicitly select a PSFCH index for PSFCH resource(s) based on a source identifier (ID) and a member ID. The source ID may be a physical layer source ID. The source ID may be an ID of a transmitting terminal that has transmitted the PSSCH.

The member ID may be used in the groupcast HARQ-ACK feedback option 2. When the groupcast HARQ-ACK feedback option 2 is applied, each of all receiving terminals within a group may individually transmit a HARQ-ACK feedback for SL data through a separate PSFCH (e.g., PSFCH resource). In a case other than the above-described exemplary embodiment, the member ID may be set to 0.

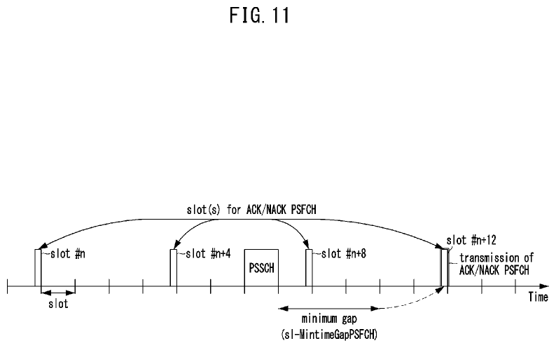

FIG. 11 is a conceptual diagram illustrating a first exemplary embodiment of a PSFCH for ACK/NACK transmission.

Referring to FIG. 11, a transmission time of a PSFCH may be the first slot (e.g., PSFCH slot) in which PSFCH transmission is possible after a preset time (e.g., sl-MinTimeGapPSFCH) from a reception time of a corresponding PSSCH. The PSFCH slot may be a slot capable of transmitting a PSFCH and/or a slot in which a PSFCH is configured. sl-MinTimeGapPSFCH may be set in consideration of a time required for processing the PSSCH after reception of the PSSCH and a time required for preparing for ACK/NACK (e.g., HARQ-ACK feedback) depending on whether reception of the PSSCH is successful. sl-MinTimeGapPSFCH may be set to 2 or 3 slots. The terminal (e.g., receiving terminal) may transmit the PSFCH in a slot #n+12, which is a slot capable of PSFCH transmission, after sl-MinTimeGapPSFCH (e.g., 3 slots) from a reception time of the PSSCH. n may be an integer greater than or equal to 0. In the present disclosure, the reception time may mean a reception start time and/or a reception end time, and the transmission time may mean a transmission start time and/or a transmission end time. The timing may mean the time and/or the duration.

Data reliability at the receiving terminal may be improved by appropriately adjusting a transmit power of the transmitting terminal according to a transmission environment. Interference to other terminals may be mitigated by appropriately adjusting the transmit power of the transmitting terminal. Energy efficiency can be improved by reducing unnecessary transmit power. A power control scheme may be classified into an open-loop power control scheme and a closed-loop power control scheme. In the open-loop power control scheme, the transmitting terminal may determine the transmit power in consideration of configuration, a measured environment, etc. In the closed-loop power control scheme, the transmitting terminal may determine the transmit power based on a transmit power control (TPC) command received from the receiving terminal.

It may be difficult due to various causes including a multipath fading channel, interference, and the like to predict a received signal strength at the receiving terminal. Accordingly, the receiving terminal may adjust a receive power level (e.g., receive power range) by performing an automatic gain control (AGC) operation to prevent a quantization error of the received signal and maintain a proper receive power. In the communication system, the terminal may perform the AGC operation using a reference signal received from the base station. However, in the sidelink communication (e.g., V2X communication), the reference signal may not be transmitted from the base station. That is, in the sidelink communication, communication between terminals may be performed without the base station. Therefore, it may be difficult to perform the AGC operation in the sidelink communication. In the sidelink communication, the transmitting terminal may first transmit a signal (e.g., reference signal) to the receiving terminal before transmitting data, and the receiving terminal may adjust a receive power range (e.g., receive power level) by performing an AGC operation based on the signal received from the transmitting terminal. Thereafter, the transmitting terminal may transmit sidelink data to the receiving terminal. The signal used for the AGC operation may be a signal duplicated from a signal to be transmitted later or a signal preconfigured between the terminals.

A time period required for the ACG operation may be 15 μs. When a subcarrier spacing of 15 kHz is used in the NR system, a time period (e.g., length) of one symbol (e.g., OFDM symbol) may be 66.7 When a subcarrier spacing of 30 kHz is used in the NR system, a time period of one symbol (e.g., OFDM symbol) may be 33.3 In the following exemplary embodiments, a symbol may mean an OFDM symbol. That is, a time period of one symbol may be twice or more than a time period required for the ACG operation.

For sidelink communication, it may be necessary to transmit a data channel for data transmission and a control channel including scheduling information for data resource allocation. In sidelink communication, the data channel may be a physical sidelink shared channel (PSSCH), and the control channel may be a physical sidelink control channel (PSCCH). The data channel and the control channel may be multiplexed in a resource domain (e.g., time and frequency resource domains).

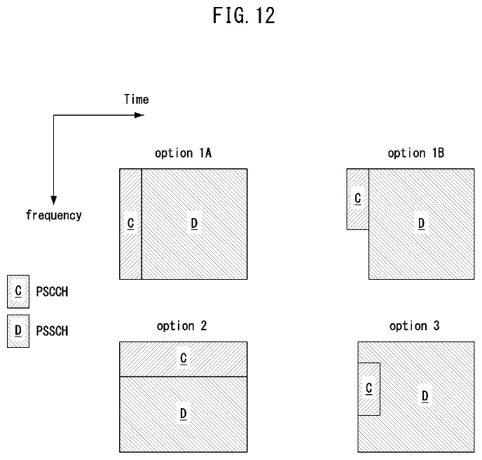

FIG. 12 is a conceptual diagram illustrating exemplary embodiments of a method for multiplexing a control channel and a data channel in sidelink communication.

Referring to FIG. 12, sidelink communication may support an option 1A, an option 1B, an option 2, and an option 3. When the option 1A and/or the option 1B is supported, a control channel and a data channel may be multiplexed in the time domain. When the option 2 is supported, a control channel and a data channel may be multiplexed in the frequency domain. When the option 3 is supported, a control channel and a data channel may be multiplexed in the time and frequency domains. The sidelink communication may basically support the option 3.

In the sidelink communication (e.g., NR-V2X sidelink communication), a basic unit of resource configuration may be a subchannel. The subchannel may be defined with time and frequency resources. For example, the subchannel may be composed of a plurality of symbols (e.g., OFDM symbols) in the time domain, and may be composed of a plurality of resource blocks (RBs) in the frequency domain. The subchannel may be referred to as an RB set. In the subchannel, a data channel and a control channel may be multiplexed based on the option 3.

In the sidelink communication (e.g., NR-V2X sidelink communication), transmission resources may be allocated based on a mode 1 or a mode 2. When the mode 1 is used, a base station may allocate sidelink resource(s) for data transmission within a resource pool to a transmitting terminal, and the transmitting terminal may transmit data to a receiving terminal using the sidelink resource(s) allocated by the base station. Here, the transmitting terminal may be a terminal that transmits data in sidelink communication, and the receiving terminal may be a terminal that receives the data in sidelink communication.

When the mode 2 is used, a transmitting terminal may autonomously select sidelink resource(s) to be used for data transmission by performing a resource sensing operation and/or a resource selection operation within a resource pool. The base station may configure the resource pool for the mode 1 and the resource pool for the mode 2 to the terminal(s). The resource pool for the mode 1 may be configured independently from the resource pool for the mode 2. Alternatively, a common resource pool may be configured for the mode 1 and the mode 2.

When the mode 1 is used, the base station may schedule a resource used for sidelink data transmission to the transmitting terminal, and the transmitting terminal may transmit sidelink data to the receiving terminal by using the resource scheduled by the base station. Therefore, a resource conflict between terminals may be prevented. When the mode 2 is used, the transmitting terminal may select an arbitrary resource by performing a resource sensing operation and/or resource selection operation, and may transmit sidelink data by using the selected arbitrary resource. Since the above-described procedure is performed based on an individual resource sensing operation and/or resource selection operation of each transmitting terminal, a conflict between selected resources may occur.

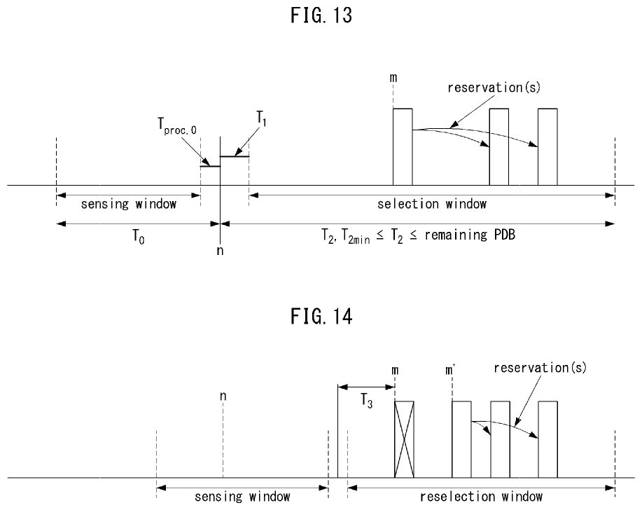

FIG. 13 is a conceptual diagram illustrating a first exemplary embodiment of a resource selection operation.

Referring to FIG. 13, a terminal (e.g., transmitting terminal) may perform a resource sensing operation within a sensing window, and may perform a resource selection operation on resource(s) (e.g., candidate resource(s)) sensed within the selection window. When the resource selection operation is triggered in a time n, the terminal may select suitable resource(s) within the selection window (e.g., a period from a time n+T₁ to a time n+T₂) based on a result of the sensing within the sensing window (e.g., a period from a time n−T₀ to a time n−T_{proc,0}).

Based on the result of the resource sensing operation, the terminal may exclude candidate resource(s) that do not satisfy a condition within the selection window. In other words, the terminal may determine the remaining candidate resources excluding the candidate resource(s) that are not suitable from all candidate resources. When a ratio of the remaining candidate resources among all resources within the selection window is less than a reference ratio, the terminal may relax the condition for excluding the candidate resource(s). For example, the terminal may increase a reference signal received power (RSRP) threshold, which is the condition for excluding candidate resource(s), by 3 dB. Thereafter, the terminal may perform the resource selection operation again. The reference ratio may be preset to one of 20%, 35%, or 50% for each priority. When the ratio of the remaining candidate resources is greater than or equal to the reference ratio, the terminal may randomly select final resource(s) to be used for SL transmission among the remaining candidate resources. The terminal may perform SL transmission using the final resource(s).

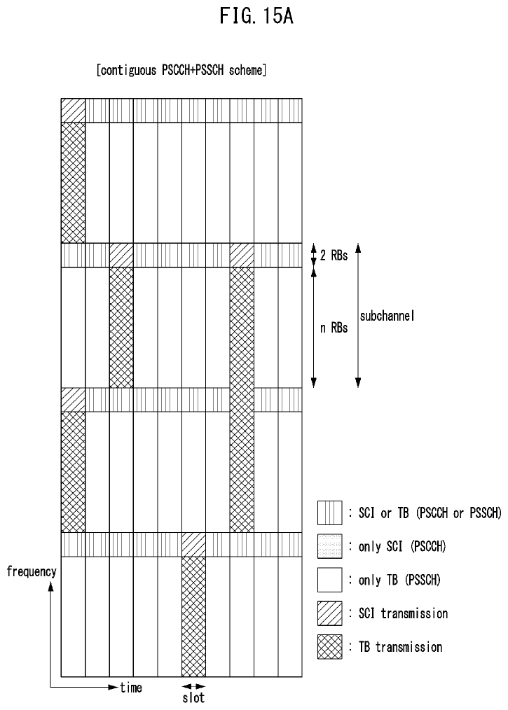

FIG. 14 is a conceptual diagram illustrating a first exemplary embodiment of a resource reselection operation.

Referring to FIG. 14, after the resource selection operation, the terminal may perform a resource reselection operation in consideration of aperiodic data transmission or the like. After performing the operations shown in FIG. 13, the terminal may perform the resource reselection operation by additionally considering a result of sensing at a time m-T₃ before actual SL transmission. The resource reselection operation may be performed within a reselection window. The terminal may further determine suitability of resource(s) reserved at the time m. When it is determined that the resource(s) reserved in the time m is suitable, the terminal may perform SL transmission using the reserved resource(s). When it is determined that the resource(s) reserved at the time m is not suitable, the terminal may reselect resource(s) for SL transmission and perform SL transmission using the reselected resource(s).

When an independent SL carrier is not configured for SL communication, some UL resources among UL resources may be configured as SL resources by an SL resource pool configuration procedure. A bitmap may be repeatedly applied to the remaining slot(s) excluding slot(s) in which at least X or more UL symbols are not configured and slot(s) in which a sidelink (S)-SSB is transmitted among slots within a specific period. X may be a natural number. The bitmap may indicate slot(s) used as SL resources. For example, slot(s) corresponding to bit(s) set to 1 among bits in the bitmap may be used as SL resources.

A case in which a 15 kHz subcarrier spacing (SCS) is applied and X or more UL symbols are configured in all slots may be assumed. When there are 10240 slots available within a direct frame number (DFN), a transmission periodicity of the S-SSB is 160 ms, and there are 2 slots used for S-SSB transmission in each S-SSB transmission period, the number of slots used for S-SSB transmission within a DFN may be 128. A bitmap for configuring SL time resources may include 10 bits. When the bitmap (e.g., bitmap including 10 bits) is repeatedly applied to the remaining 10112 slots excluding 128 slots used for S-SSB transmission among 10240 slots, there may be two slots (e.g., reserved slots) to which the bitmap is not applied. It may be necessary to exclude the two reserved slots. When excluding the two reserved slots from 10112 slots, 10110 slots may remain. The bitmap (e.g., bitmap including 10 bits) may be repeatedly applied 1011 times to 10110 slots. When the bitmap is set to ‘1111000000’ and slots corresponding to bits set to 1 are used as SL resources, 4044 slots may be configured as SL resources within the DFN. In other words, 4044 slots among 10240 slots may be used for SL communication by configuring the SL resource pool.

The sidelink communication system supporting Release-16 may be designed for terminals (e.g., vehicle-mounted terminals, vehicle UEs (V-UEs)) that do not have restrictions on battery capacity. Therefore, a power saving issue may not be greatly considered in resource sensing/selection operations for such the terminals. However, in order to perform sidelink communication with terminals having restrictions on battery capacity in the sidelink communication system supporting Release-17 (e.g., a terminal carried by a pedestrian, a terminal mounted on a bicycle, a terminal mounted on a motorcycle, a pedestrian UE (P-UE)), power saving methods will be required. In the present disclosure, a ‘V-UE’ may refer to a terminal that has no significant restrictions on battery capacity, a ‘P-UE’ may refer to a terminal with restrictions on battery capacity, and a ‘resource sensing/selection operation’ may refer to a resource sensing operation and/or a resource selection operation. The resource sensing operation may refer to a partial sensing operation or a full sensing operation. The resource selection operation may refer to a random selection operation. In addition, in the present disclosure, an ‘operation of a terminal’ may be interpreted as an ‘operation of a V-UE’ and/or ‘operation of a P-UE’.

For power saving in the LTE V2X, a partial sensing operation and/or a random selection operation has been introduced. When the partial sensing operation is supported, the terminal may perform resource sensing operations in partial periods instead of an entire period within a sensing window, and may select a resource based on a result of the partial sensing operation. According to such the operation, power consumption of the terminal may be reduced.

In the Release-14 LTE V2X, only periodic data transmission and reception operations may be possible. In the Release-14 LTE V2X, the terminal may arbitrarily select candidate slots within a resource selection period (e.g., selection window) in consideration of a preset minimum number, and perform a partial sensing operation in consideration of a periodicity of k×100 ms. k may be signaled by a bitmap (e.g., bitmap including 10 bits). k may be determined according to a position of a bit included in the bitmap. For example, 10 bits included in the bitmap may respectively correspond to values from 1 to 10 from the MSB, and the periodicity may be determined based on a value corresponding to a bit set to 1. The value corresponding to the bit set to 1 may be k.

When the MSB is set to 1 in the bitmap, k may be 1. In this case, the terminal may perform a partial sensing operation in consideration of a periodicity of 100 ms (=1×100 ms). When a bit next to the MSB in the bitmap is set to 1, k may be 2. In this case, the terminal may perform a partial sensing operation in consideration of a periodicity of 200 ms (=2×100 ms). When the LSB is set to 1 in the bitmap, k may be 10. In this case, the terminal may perform a partial sensing operation in consideration of a periodicity of 1000 ms (=10×100 ms).

In the Release-14 LTE V2X, the periodicity (e.g., the periodicity of partial sensing operation) may be set to 20 ms or 50 ms. A periodicity of 20 ms or 50 ms may not be supported in a resource pool for a P-UE. In the NR communication system, a shorter periodicity may be supported in addition to {0, 100 ms, 200 ms, . . . , 1000 ms}. The short periodicity may be {1 ms, 2 ms, . . . , 99 ms}. Up to 16 periodicities may be selected from the resource pool, and the selected periodicities may be preconfigured to the terminal. The terminal may perform the resource sensing operation and/or the resource (re)selection operation using one or more of the configured periodicities. When a random selection operation is supported, the terminal may randomly select a resource without performing a resource sensing operation. Alternatively, the random selection operation may be performed together with the resource sensing operation. For example, the terminal may determine resources by performing the resource sensing operation, and may select resource(s) by performing the random selection operation within the determined resources.

In the LTE V2X supporting Release-14, a resource pool in which the partial sensing operation and/or random selection operation can be performed may be configured independently of a resource pool in which the full sensing operation can be performed. A resource pool capable of performing the random selection operation, a resource pool capable of performing the partial sensing operation, and a resource pool capable of performing the full sensing operation may be independently configured. In other words, a random selection operation, a partial sensing operation, or both a random selection operation and a partial sensing operation may be configured for each resource pool. When both a random selection operation and a partial sensing operation are configured for a resource pool, the terminal may select one operation among the random selection operation and the partial sensing operation, select a resource by performing the selected operation, and use the selected resource to perform SL communication.

In the LTE V2X supporting Release-14, sidelink (SL) data may be periodically transmitted based on a broadcast scheme. In the NR communication system, SL data may be transmitted based on a broadcast scheme, multicast scheme, groupcast scheme, or unicast scheme. In addition, in the NR communication system, SL data may be transmitted periodically or aperiodically. A transmitting terminal may transmit SL data to a receiving terminal, and the receiving terminal may transmit a HARQ feedback (e.g., acknowledgement (ACK) or negative ACK (NACK)) for the SL data to the transmitting terminal on a PSFCH. In the present disclosure, a transmitting terminal may refer to a terminal transmitting SL data, and a receiving terminal may refer to a terminal receiving the SL data.

A terminal having reduced capability (hereinafter, referred to as ‘RedCap terminal’) may operate in a specific usage environment. The capability of the RedCap terminal may be lower than capability of a new radio (NR) normal terminal, and may be higher than those of an LTE-machine type communication (LTE-MTC) terminal, a narrow band (NB)-Internet of things (IoT) terminal, and a low power wide area (LPWA) terminal. For example, a terminal (e.g., surveillance camera) requiring a high data rate and not high latency condition and/or a terminal (e.g., wearable device) requiring a non-high data rate, high latency condition, and high reliability may exist. In order to support the above-described terminals, the maximum carrier bandwidth in FR1 may be reduced from 100 MHz to 20 MHz, and the maximum carrier bandwidth in FR2 may be reduced from 400 MHz to 100 MHz. The number of reception antennas of the RedCap terminal may be smaller than the number of reception antennas of the NR normal terminal. When the carrier bandwidth and the number of reception antennas are reduced, reception performance at the RedCap terminal may decrease, and accordingly, the coverage of the RedCap terminal may decrease.

The communication system (e.g., NR system) may operate in a frequency band higher than a 52.6 GHz frequency band. As a frequency of the frequency band in which the communication system operates increases, a frequency offset error and a phase noise may increase. The use of a large SCS may be necessary for robust operations in such a environment. In an FR2 band, a 60 kHz SCS and/or a 120 kHz SCS may be supported, and a 480 kHz SCS and/or a 960 kHz SCS may be additionally supported. In addition, design of physical layer signals and channels and physical layer procedures according to the new SCSs may be required. Regarding an initial access procedure, 120 kHz SSBs and/or 240 kHz SSBs may be supported in an FR2 band, and 480 kHz SSBs and/or 960 kHz SSBs may be additionally supported. Here, the 120 kHz SSB may refer to an SSB transmitted in a radio resource to which the 120 kHz SCS is applied, and the 240 kHz SSB may refer to an SSB transmitted in a radio resource to which the 240 kHz SCS is applied. A method for configuring an initial BWP and an SSB burst set pattern for supporting the new SCSs may be required.

In the 3GPP NR Release-18, techniques for carrier aggregation (CA) for improved transmission speed of data, support of operations in an unlicensed spectrum, performance improvement in an FR2 licensed spectrum, and/or co-channel coexistence between LTE SL and NR SL may be discussed. In an initial intelligent transport system (ITS) band, a cellular V2X (C-V2X) service was supported for LTE SL terminals, but may also be supported for NR SL terminals over time. Accordingly, the C-V2X service may be mainly provided to NR SL terminals. Here, the LTE SL terminal may refer to a terminal supporting LTE SL communication, and the NR SL terminal may refer to a terminal supporting NR SL communication. The ITS band may be restricted to limited resources. Considering the above-described circumstances, co-channel coexistence between LTE SL terminals and NR SL terminals may be required for smooth migration between LTE SL communication and NR SL communication, continuity of smooth services through re-farming of frequency resources, and/or enhancement of resource efficiency.

For co-channel coexistence between an LTE SL terminal and an NR SL terminal, the following two schemes may be discussed.
First scheme: resource pool separation between two radio access technologies (RATs)
Second scheme: dynamic resource sharing using overlapping resource pools between two RATs

When the first scheme is used, a resource pool for LTE SL and a resource pool for NR SL may be separated. When the second scheme is used, resources (e.g., resource pools) between LTE SL and NR SL may overlap. Resources may be dynamically shared within the overlapping resources, and LTE SL communication and/or NR SL communication may be performed using the shared resources. According to the first scheme, resources for LTE SL communication and resources for NR SL communication may be configured independently, and the resources for LTE SL communication and the resources for NR SL communication may not overlap each other. Therefore, the LTE SL communication and the NR SL communication may be performed without problems.

According to the first scheme, it may be difficult to flexibly allocate resources according to occupancy rates of LTE SL terminals and/or NR SL terminals. When a base station does not pre-allocate resources to an out-of-coverage (OCC) terminal, the OCC terminal may perform SL communication using preconfigured default resources. The OCC terminal (e.g., LTE SL terminal and/or NR SL terminal) may refer to a terminal located outside a coverage of the base station. The LTE SL terminals to which services are initially provided may be configured to occupy most of the resources in the ITS band, and services for the NR SL terminals may be newly provided over time. Default resources for NR SL terminals may be configured as resources other than default resources configured for LTE SL terminals within the ITS band. Resources other than the default resources configured for LTE SL terminals within the ITS band may be very small. In this case, only some default resources for NR SL terminals may be configured. Alternatively, default resources for NR SL terminals may not be configured. In this case, efficient use of resources may be impossible.

Considering the introduction of NR SL terminals, the default resources of LTE SL terminals may be limitedly configured. In this case, efficient use of resources may be limited, and performance of the initial system may deteriorate. Reconfiguration and/or modification of the default resources configured in the terminal may be impossible until the terminal is replaced. Therefore, limiting the default resources of the LTE SL terminal may not be preferable in terms of resource efficiency. In the present disclosure, the terminal may be interpreted as an LTE SL terminal, an NR SL terminal, or both of an LTE SL terminal and an NR SL terminal depending on the context.

Considering the above-described problems, it may be preferable to support the second scheme. In other words, it may be preferable to support a scheme of dynamically sharing overlapping resources between LTE SL terminals and NR SL terminals. In order to support the second scheme, when the LTE SL terminal and the NR SL terminal operate in the same resources, methods for mitigating collision and/or interference between the LTE SL terminal and the NR SL terminal may be required. In the present disclosure, resource sharing methods between the LTE SL terminal and the NR SL terminal in a situation where the LTE SL terminal and the NR SL terminal coexist will be proposed. In other words, resource sharing methods between the terminals when the second scheme is used will be proposed. The present disclosure may be applied not only to an environment in which the second scheme is used but also in an environment in which the first scheme is used.

The NR SL terminal may operate based on the mode 1 or mode 2. When the NR SL terminal supports the mode 1, resources for the NR SL terminal (e.g., resources for SL communication) may be configured by the base station. When the NR SL terminal supports the mode 2, the NR SL terminal may select resources by itself based on a result of a resource sensing operation. The LTE SL terminal may operate based on a mode 3 or mode 4. When the LTE SL terminal supports the mode 3, resources for the LTE SL terminal (e.g., resources for SL communication) may be configured by the base station. When the LTE SL terminal supports the mode 4, the LTE SL terminal may select resources by itself based on a result of a resource sensing operation.

Based on the type of terminal and the mode supported by the terminal, combinations listed in Table 6 below may be considered.

TABLE 6

| | Mode supported by LTE | Mode supported by NR |
|---|---|---|
| | SL terminal | SL terminal |
| Case 1 | Mode 3 | Mode 1 |
| Case 2 | Mode 3 | Mode 2 |
| Case 3 | Mode 4 | Mode 1 |
| Case 4 | Mode 4 | Mode 2 |

In Case 1, the LTE SL terminal may support the mode 3, and the NR SL terminal may support the mode 1. In other words, in Case 1, both the LTE SL terminal and the NR SL terminal may be controlled by the base station and may perform SL communication using resources configured by the base station. Therefore, even when overlapping resources between the LTE SL terminal and the NR SL terminal are shared, collision and/or interference problems may not occur. In Case 2 and Case 3, the LTE SL terminal and the NR SL terminal may select resources based on different schemes. Cases 2 and 3 may not be considered because they are not common situations. In Case 4, the LTE SL terminal may support the mode 4, and the NR SL terminal may support the mode 2. In other words, in Case 4, both the LTE SL terminal and the NR SL terminal may select resources by themselves based on results of resource sensing operations. In Case 4, a method for sharing resources between the LTE SL terminal and the NR SL terminal may be required.

In the environment where the LTE SL terminal and the NR SL terminal coexist, the LTE SL terminal (e.g., terminal supporting Release-15) cannot know the existence of the NR SL terminal. A terminal equipped with an LTE SL communication module and an NR SL communication module (e.g., terminal introduced from or after Release-16) may support some coexistence functions in the environment in which two RATs (e.g., LTE and NR) coexist. In the environment where two RATs coexist, transmission and reception operations may be performed based on a prioritization rule. The LTE SL communication module may be referred to as an LTE SL module (or LTE module), and the NR SL communication module may be referred to as an NR SL module (or NR module). In Release-18, an active coexistence function between the LTE SL terminal and the NR SL terminal can be supported by dynamic resource sharing between two RATs.

For dynamic resource sharing between two RATs, it may be assumed that a terminal is equipped with both the LTE SL module and the NR SL module. A resource region supporting dynamic resource sharing between two RATs may be configured in units of a resource pool. Configuration information of the resource region supporting dynamic resource sharing may be included in system information for configuring a resource pool. For example, the configuration information may include an indicator supporting whether dynamic resource sharing is supported. The size of the indicator may be 1 bit. The indicator having a size of 1 bit may be referred to as a ‘1-bit indicator’. The indicator set to a first value may indicate that the dynamic resource sharing function is enabled. The indicator set to a second value may indicate that the dynamic resource sharing function is disabled. When a resource pool is configured to support dynamic resource sharing, the terminal may perform an NR SL resource selection operation based on a sensing result of the LTE SL module. In the present disclosure, the terminal may refer to a terminal equipped with the LTE SL module and the NR SL module.

[Resource Selection Method Using LTE SL Information]

The terminal equipped with the LTE SL module and the NR SL module may simultaneously perform an LTE SL resource sensing operation and an NR SL resource sensing operation. The LTE SL resource sensing operation may refer to a resource sensing operation for LTE SL communication, and the NR SL resource sensing operation may refer to a resource sensing operation for NR SL communication. A result of the resource sensing operation performed by the LTE SL module may be delivered to the NR SL module. The NR SL module may select resource(s) for transmission of SL data based on the result of the resource sensing operation of the LTE SL module. In other words, the terminal may perform an NR SL resource selection operation based on the result of the LTE SL resource sensing operation. The result of the resource sensing operation may be referred to as ‘sensing result’ or ‘sensing information’. The sensing result (or sensing information) may include candidate resource(s). The sensing result delivered from the LTE SL module to the NR SL module within one terminal may be candidate resource(s) used for transmission operations of the LTE SL module and/or candidate resource(s) in which reception operations of the LTE SL module are performed. Alternatively, the sensing result delivered from the LTE SL module to the NR SL module within one terminal may be resource(s) determined by the LTE SL module as resource(s) used (or to be used) by another terminal (e.g., another LTE terminal).

Information on candidate resource(s) used for transmission and/or reception operation of the LTE SL module may be processed by an in-device coexistence procedure. It may be preferable that the information on the resource(s) determined by the LTE SL module as resources used (or to be used) by another terminal (e.g., another LTE terminal) is delivered from the LTE SL module to the NR SL module. The terminal may perform a resource selection operation (e.g., LTE SL resource selection operation or NR SL resource selection operation) based on the sensing result of the NR SL module and the sensing result of the LTE SL module. The sensing result of the NR SL module may be referred to as ‘NR SL sensing result’, ‘NR SL sensing information’, ‘NR sensing result’, or ‘NR sensing information’, and the sensing result of the LTE SL module may be referred to as ‘LTE SL sensing result’, ‘LTE SL sensing information’, ‘LTE sensing result’, or ‘LTE sensing information’.

The terminal may exclude resource(s) determined used (or to be used) by another terminal (e.g., another NR terminal) from the candidate resources based on the NR SL sensing result, and additionally, may exclude resource(s) determined used (or to be used) by another terminal (e.g., another LTE terminal) from the candidate resources based on the LTE SL sensing result. The NR module may receive the LTE SL sensing result from the LTE module, and based on the LTE SL sensing result, the NR module may determine that LTE SL candidate resources fully or partially overlap with NR SL candidate resources. In this case, the NR module may exclude the NR SL candidate resources from the existing candidate resources. The LTE SL candidate resources may correspond to the LTE SL sensing result, and the NR SL candidate resources may correspond to the NR SL sensing result. The NR module may refer to the NR SL module, and the LTE module may refer to the LTE SL module.

In the resource selection operation, the candidate resources may be excluded based on the sensing result. In addition, resources on which a resource sensing operation for SL transmission has not been performed and/or resources on which an SL reception operation has not been performed may be excluded from the candidate resources. In this case, it may be preferable that not only transmission resources of the NR SL module (e.g., resources on which the sensing operation has not been performed due to SL transmission) but also transmission resources of the LTE SL module (e.g., resources on which the resource sensing operation has not been performed due to SL transmission) are excluded from the candidate resources.

In order to easily perform the operation of excluding NR SL candidate resources based on the LTE SL information, it may be preferable to configure an NR SL non-preferred candidate resource set based on the LTE SL information. The NR SL module (e.g., terminal) may configure NR SL candidate resource(s) overlapping with resource(s) (e.g., resources used (or to be used) by other LTE terminal(s) according to the LTE SL information received from the LTE SL module to be the NR SL non-preferred candidate resource set. The NR SL module (e.g., terminal) may compare NR SL non-preferred candidate resource(s) with the existing NR SL candidate resource(s), and may exclude candidate resource(s) overlapping between the NR SL non-preferred candidate resource(s) and the existing NR SL candidate resource(s) from the existing NR SL candidate resource(s). The LTE SL information received from the LTE SL module may include information on resources reserved by LTE terminal(s) (e.g., location information, subframe information, and/or subchannel information of time and/or frequency resources), measurement information (e.g., RSRP) of the reserved resources, periodicity of the reserved resources (e.g., reservation periodicity), information on resources used for SL transmission operations of the LTE SL module (e.g., location information of time and/or frequency resources, and reservation periodicity of the resources), information on resources not monitored due to SL transmission operations of the LTE SL module (e.g., location information of time and/or frequency resources), priority, received signal strength indicator (RSSI), LTE SL reference timing information, or combinations thereof. The priority may refer to a data priority and/or a transmission priority.

In the resource selection operation, it may be preferable that NR SL candidate resource(s) (e.g., candidate single-slot resource(s)) overlapping fully or partially with a resource region indicated by the LTE SL information received from the LTE SL module are excluded. It may be preferable to exclude NR SL candidate resource(s) satisfying condition(s) considering an LTE SL subcarrier spacing (SCS) and an NR SL SCS in the resource selection operation. The LTE SL SCS may refer to an SCS applied to LTE SL communication, and the NR SL SCS may refer to an SCS applied to NR SL communication. The LTE SL SCS may be referred to as ‘SCS_{LTE}’, and the NR SL SCS may be referred to as ‘SCS_{NR}’.

NR SL slot(s) corresponding to a subframe (e.g., LTE subframe) indicated by the LTE SL information in the time domain may be selected. In this case, when SCS_{LTE} and SCS_{NR} are the same (e.g., when both of SCS_{LTE} and SCS_{NR} are 15 kHz), one LTE subframe may correspond to one NR SL slot. When SCS_{LTE} and SCS_{NR} are different, one LTE subframe may correspond to SCS_{NR}/SCS_{LTE} NR SL slot(s). For example, when SCS_{LTE} is 15 kHz and SCS_{NR} is 30 kHz, the terminal may select 2 (=30 kHz/15 kHz) NR SL slots corresponding to one LTE subframe. When periodicity information is additionally received from the LTE SL module (e.g., when the LTE SL information also includes the periodicity information), the terminal may consider periodic time resources by applying the periodicity information to information on the LTE subframe.

NR SL candidate resource(s) fully or partially overlapping with a subchannel (e.g., LTE subchannel) indicated by the LTE SL information in the frequency domain may be selected. The expression that some frequency resources (e.g., frequency regions) partially overlap may mean that some subchannel(s) overlap, some RB(s) within a subchannel overlap, and/or some frequency resource(s) within an RB overlap. When the LTE SL SCS and the NR SL SCS are different, some frequency resource(s) within an RB may overlap.

The terminal may exclude NR SL candidate resource(s) satisfying the above-described overlapping condition(s) in the time and frequency domains in the resource selection operation. When the LTE SL module provides RSRP information, the terminal may perform the NR SL resource selection operation in consideration of the RSRP information of LTE SL. For example, the terminal may exclude NR SL candidate resource(s) overlapping with LTE SL candidate resource(s) having an RSRP greater than or equal to a threshold (e.g., RSRP threshold) in the resource selection operation. The candidate resource(s) (e.g., NR SL candidate resource(s)) excluded in the resource selection operation may not be used in NR SL communication. When the LTE SL module provides priority information, the terminal may perform the NR SL resource selection operation in consideration of a priority of LTE SL (e.g., data priority and/or transmission priority). When a priority of an NR SL candidate resource satisfying the overlapping condition(s) in the time and frequency domains is lower than a priority of an LTE SL candidate resource, the terminal may exclude the NR SL candidate resource in the resource selection operation. The priority information of the LTE SL candidate resource may be included in the LTE SL information provided by the LTE SL module.

If an RSRP of an LTE SL transmission resource reserved by another terminal is higher than an RSRP threshold based on a priority of an NR SL transmission resource and a priority of an LTE SL transmission resource, an NR SL candidate resource corresponding to the reserved LTE SL transmission resource may be excluded in the resource selection operation. The RSRP threshold may be a value configured for the NR SL resource selection operation (e.g., the existing NR SL resource selection operation) or the LTE SL resource selection operation (e.g., the existing LTE SL resource selection operation). Alternatively, the RSRP threshold may be a newly configured value separate from the value configured for the NR SL resource selection operation and/or the LTE SL resource selection operation.

In addition to the overlapping condition(s) in the time and frequency domains, some or all of one or more additional conditions may be considered in the resource selection operation. Whether to apply the one or more additional conditions are applied may be configured to the terminal through signaling (e.g., system information signaling, UE-specific RRC signaling, PC5-RRC signaling). Whether to apply the one or more additional conditions may be configured for each resource pool.

NR SL non-preferred candidate resource(s) may be determined based on the LTE SL information. The NR SL non-preferred candidate resource(s) may be excluded from the NR SL candidate resources. If a criterion for delivering the remaining NR SL candidate resources to a higher layer is not satisfied, the remaining NR SL candidate resources may not be delivered to the higher layer. The NR SL candidate resources having been excluded based on an RSRP of the LTE SL candidate resources may be added again to the NR SL candidate resources. For example, when a ratio of the remaining NR SL candidate resources to the total resources is less than X %, the remaining NR SL candidate resources may not be delivered to the higher layer. Among the excluded NR SL candidate resources, excluded NR SL candidate resources overlapping with an LTE SL candidate resource having a small RSRP may be preferentially added to the NR SL candidate resources. Alternatively, among the excluded NR SL candidate resources, excluded NR SL candidate resources having an RSRP greater by a specific value than or equal to an RSRP of an LTE SL candidate resource may be preferentially added to the NR SL candidate resources. Alternatively, the terminal may increase the RSRP threshold by a specific value (e.g., 3 dB) and perform the resource selection operation using the increased RSRP threshold. As another method, the terminal may randomly select at least one excluded NR SL candidate resource from among the excluded NR SL candidate resources, and add the selected at least one excluded NR SL candidate resource to the NR SL candidate resources. The specific value may be configured to the terminal through signaling (e.g., system information signaling, UE-specific RRC signaling, PC5-RRC signaling, control information signaling). When the specific value is not configured to the terminal, the terminal may determine the specific value in an implementation manner.

The LTE SL resource sensing operation may be different from the NR SL resource sensing operation. The LTE SL terminal may determine a candidate resource set (e.g., SA) based on SCI and/or RSRP measurement results, and then determine a final candidate resource set (e.g., SB) based on RSSI measurement results. Information on the final candidate resource set may be delivered to the higher layer of the LTE SL terminal. The LTE SL terminal (e.g., higher layer entity) may perform the resource selection operation based on the final candidate resource set. In other words, the LTE SL terminal may select a final transmission resource within the final candidate resource set. The final candidate resource set (e.g., final candidate resources) may be considered as resources not used by other LTE SL terminal(s), and resources that do not belong to the final candidate resource set may be considered as resources used by other LTE SL terminal(s). In order to avoid collision with other LTE SL terminal(s), it may be preferable to exclude resources overlapping with resources that do not belong to the final candidate resource set from the NR SL candidate resource(s).

The NR SL module may receive information on the final candidate resource set (e.g., final candidate resources) from the LTE SL module, and may perform the NR SL resource selection operation in consideration of the final candidate resource set. When information on the final candidate resource set is not received from the LTE SL module, the NR SL module may perform the NR SL resource selection operation without considering the final candidate resource set of the LTE SL module. Whether information on the final candidate resource set of the LTE SL module is transmitted may be configured by signaling (e.g., system information signaling, UE-specific RRC signaling, PC5-RRC signaling, control information signaling). Whether information on the final candidate resource set of the LTE SL module is transmitted may be configured for each resource pool.

[Resource Configuration Method for Coexistence Between LTE SL Terminal and NR SL Terminal]

It may be preferable to configure NR SL resources in consideration of LTE SL resource configuration. An LTE SL subchannel may be configured based on two schemes. As the first scheme, a PSSCH resource and a PSSCH resource may be configured contiguously in the frequency domain. As the second scheme, a PSCCH resource and a PSSCH resource may be configured apart from each other in the frequency domain. In other words, the PSCCH resource and the PSSCH resource may be configured to be non-contiguous in the frequency domain.

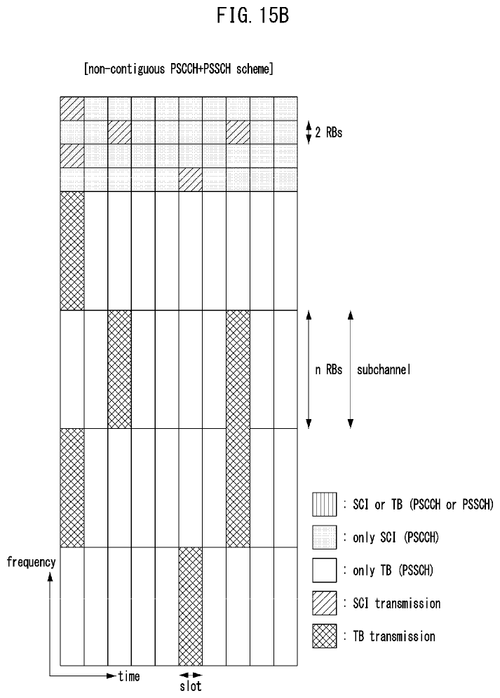

FIG. 15A is a conceptual diagram illustrating a first exemplary embodiment of a method of configuring a PSCCH resource and a PSSCH resource to be contiguous, and FIG. 15B is a conceptual diagram illustrating a first exemplary embodiment of a method of configuring a PSCCH resource and a PSSCH resource to be non-contiguous.

Referring to FIG. 15A, a PSCCH resource and a PSSCH resource may be configured to be contiguous in the frequency domain based on a frequency division multiplexing (FDM) scheme. A frequency resource of a PSCCH may include 2 RBs, and a frequency resource of a PSSCH may include n RBs. n may be a natural number. n may be configured through signaling. A subchannel may include (n+2) RBs. When the PSSCH is transmitted in a plurality of subchannels, two RBs belonging to the first subchannel may be used for PSCCH transmission, and two RBs belonging to the remaining subchannel(s) may be used for PSSCH transmission.

Referring to FIG. 15B, a PSCCH resource and a PSSCH resource may be configured to be non-contiguous in the frequency domain based on an FDM scheme. In other words, the PSSCH resource may be separated from the PSCCH resource in the frequency domain. One PSCCH resource may include two RBs. PSCCH resources may be configured contiguously in the frequency domain. One PSSCH resource may include n RBs. PSSCH resources may be configured contiguously in the frequency domain. Each subchannel may include n RBs. Each of the method of FIG. 15A (e.g., contiguous PSCCH+PSSCH scheme) and the method of FIG. 15B (e.g., non-contiguous PSCCH+PSSCH scheme) may have advantages and disadvantages. The method of FIG. 15A or the method of FIG. 15B may be used according to the communication system and/or surrounding situation.

For co-channel coexistence between LTE SL terminal and NR SL terminal, NR SL resources may be configured in consideration of LTE SL resource configuration. For example, the NR SL resources may be configured according to an LTE SL resource grid in consideration of a ratio between the LTE SL SCS and the NR SL SCS.

When the same SCS is used for two RATs (e.g., LTE and NR), the size of the NR SL subchannel may be configured to be equal to the size of the LTE SL subchannel. When configuration of the LTE SL resources is the same as the exemplary embodiment of FIG. 15A, the NR SL subchannel may be configured to include (n+2) RBs. When configuration of the LTE SL resources is the same as the exemplary embodiment of FIG. 15B, the NR SL subchannel may be configured to include n RBs. The size of the NR SL subchannel and the size of the LTE SL subchannel may be configured to have an integer multiple relationship. The size of the first RAT subchannel (e.g., frequency resource size) may be an integer multiple of the size of the second RAT subchannel. When the first RAT is LTE (e.g., LTE communication technology), the second RAT may be NR (e.g., NR communication technology). When the first RAT is NR, the second RAT may be LTE. The size of the NR SL subchannel may be set to ½ of the size of the LTE SL subchannel. In this case, one LTE SL subchannel may include two NR SL subchannels. Alternatively, the size of the NR SL subchannel may be set to twice the size of the LTE SL subchannel. In this case, one NR SL subchannel may include two LTE SL subchannels. In addition to the above-described two times, various integer multiples may be applied in the present disclosure.

When the SCSs of the two RATs are different, the size of the NR SL subchannel may be set in consideration of an SCS ratio. The LTE SL SCS may be 15 kHz, and the NR SL SCS may be 30 kHz. In this case, the number of RBs included in the NR SL subchannel may be configured to be equal to the number of RBs included in the LTE SL subchannel such that the size of the NR SL subchannel (e.g., frequency resource size) is twice the size of the LTE SL subchannel. A ratio between the LTE SL SCS (15 kHz) and the NR SL SCS (30 kHz) may be ½. In this case, the number of RBs included in the NR SL subchannel may be set to ½ of the number of RBs included in the LTE SL subchannel such that the size of the NR SL subchannel (e.g., frequency resource size) is the same as the size of the LTE SL subchannel. In addition to the above-described SCSs (e.g., 15 kHz and 30 kHz), various SCSs may be applied in the present disclosure.

When the SCSs of the two RATs are the same, an integer multiple relationship may be established between the first RAT subchannel and the second RAT subchannel. When the SCSs of the two RATs are different, the size of the subchannel may be set in consideration of a ratio between the SCS of the first RAT and the SCS of the second RAT. For example, the size of the NR SL subchannel may be configured to be an integer multiple of the size of the LTE SL subchannel. Alternatively, the size of the NR SL subchannel may be configured to be the same as the size of the LTE SL subchannel. When an SL resource grid of the first RAT and an SL resource grid of the second RAT are aligned, complexity and/or ambiguity in the resource selection operation may be reduced. In addition, the efficiency of resource use can be improved. The case when the SL resource grid of the first RAT and the SL resource grid of the second RAT are aligned may include the case when an integer multiple relationship is established between the size of the subchannel of the first RAT and the size of the subchannel of the second RAT. When LTE SL resources are configured based on the method of FIG. 15B (e.g., non-contiguous PSCCH+PSSCH scheme), it may be preferable for NR SL resources to be configured only in a PSSCH resource region of LTE SL.

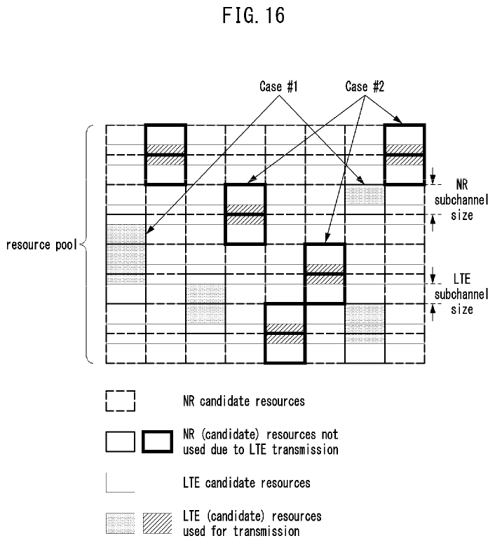

FIG. 16 is a conceptual diagram illustrating an example in which resource grids are not aligned between LTE SL and NR SL.

Referring to FIG. 16, resource waste in Case #1 may be relatively small even when resource grids between LTE SL and NR SL are not aligned. When resource grids between LTE SL and NR SL are not aligned, the number of NR SL resources not used due to the use of LTE SL resources may be large in Case #2. The waste of resources in Case #2 may be greater than the waste of resources in Case #1. Regardless of the SCSs of the two RATs, when the NR SL resource grid remains the same as the LTE SL resource grid or when an integer multiple relationship is established between the NR SL resource grid and the LTE SL resource grid, resource waste may be reduced, and efficient use of resources may be possible.

The size of the LTE SL subchannel may be set to 4, 5, 6, 8, 9, 10, 12, 15, 16, 18, 20, 25, 30, 48, or 50 RBs. The size of the NR SL subchannel may be set to 10, 12, 15, 20, 25, 50, 75, or 100 RBs. For alignment of the resource grids between two RATs, it may be preferable that an integer multiple relationship is established between the NR SL resource grid and the LTE SL resource grid. Since the size of the LTE SL sub channel may be different from the size of the NR SL subchannel, it may be difficult to configure the size of the NR SL subchannel to have an integer multiple relationship with the size of the LTE SL subchannel. In order to solve the above-described problem, it may be preferable to add configurable NR SL subchannel sizes (e.g., number of RBs). For example, not only the existing sizes of the NR SL subchannel (e.g., 10, 12, 15, 20, 25, 50, 75, or 100 RBs) but also the new sizes of the NR SL subchannel (e.g., 4, 5, 6, 8, 9, 16, 18, 30, and/or 48 RBs) may be used. In other words, 4, 5, 6, 8, 9, 16, 18, 30, and/or 48 RBs may be added as the sizes of the NR SL subchannel.

According to the above-described method, the NR SL subchannel may be configured to have various sizes. In this case, the complexity of NR SL communication (e.g., NR SL system) may increase, and a coexistence issue with the legacy NR SL terminals may occur. Therefore, it may be preferable to reduce the number of new sizes of the NR SL subchannel to be added. When the LTE SL subchannel includes 5 RBs and the NR SL subchannel includes RBs, an integer multiple relationship may be established between the LTE SL subchannel and the NR SL subchannel. Among the new sizes of the NR SL subchannel to be added, size(s) having an integer multiple relationship with the size of the LTE SL subchannel may be excluded. The new sizes of the NR SL subchannel to be added may be limited to 8, 9, 16, 18, 30, and/or 48 RBs. In addition, among the new sizes of the NR SL subchannel to be added, size(s) having an integer multiple relationship may be excluded. For example, since 16 is a multiple of 8 and 18 is a multiple of 9, 16 RBs and 18 RBs may be added as the new sizes of the NR SL subchannel instead of 8 RBs and 9 RBs.

The subchannel size of less than or equal to 10 RBs may not be supported in the existing NR SL system. As in the exemplary embodiment of FIG. 12, the PSCCH/PSSCH multiplexing scheme in the NR SL system may be different from the PSCCH/PSSCH multiplexing scheme in the LTE SL system. Considering the above-described circumstances, it may not be preferable to add RBs less than or equal to 10 RBs as the new size of the NR SL subchannel. Therefore, it may be preferable to limit the new sizes of the NR SL subchannel to be added to 16, 18, 30, and/or 48 RBs. Alternatively, when the subchannel size is 18 RBs or 48 RBs and the PSCCH size of the LTE SL system is 2 RBs, the size of the subchannel may be 20 RBs or 50 RBs. 20 RBs and 50 RBs may be the subchannel sizes which are supported by the NR SL system. Therefore, it may be preferable to limit the new sizes of the NR SL subchannel to be added to 16 and/or 30 RBs.

In the exemplary embodiment of FIG. 16, resource waste may occur when resource grids between the two RATs are not aligned. Additional methods to reduce the waste of resources are needed. In the resource selection operation, an RSRP for a resource determined to be used by another terminal may be measured, and when the measured RSRP is greater than or equal to an RPRP threshold, the resource may be excluded from the candidate resources. When an LTE SL subchannel determined to be used by another terminal partially overlaps with an NR SL subchannel, an RSRP for the overlapping resource region may be measured, and a scaling considering the total size of the NR SL subchannel may be applied to the measured RSRP. When the scaled RSRP is greater than or equal to the RSRP threshold, the corresponding resource (e.g., NR SL subchannel) may be excluded from the candidate resources. Alternatively, when an LTE SL subchannel determined to be used by another terminal partially overlaps an NR SL subchannel, an RSRP for the entire resource region of the NR SL subchannel may be measured, and when the measured RSRP is greater than or equal to the RSRP threshold, the corresponding resource (e.g., NR SL subchannel) may be excluded from the candidate resources. No reference signal may exist in resource regions other than the overlapping resource region. Therefore, an RSSI may be used instead of the RSRP.

Even when resource grids (e.g., frequency resource grids) between two RATs are aligned or when an integer multiple relationship is established between the subchannel size of the first RAT and the subchannel size of the second RAT, if SCSs of the two RATs are different, an appropriate resource selection operation considering the different SCSs may be required. The size of resources excluded in the NR SL resource selection operation according to the LTE SL sensing result may be configured. In this case, NR SL subchannel(s) corresponding to a region overlapping LTE SL resources (e.g., LTE SL sensing result) in the frequency domain may be selected. The number of slots excluded in the time domain may be determined by considering a ratio of the SCSs of two RATs (e.g., SCS_{NR}/SCS_{LTE}). For example, when the LTE SL SCS is 15 kHz and the NR SL SCS is 30 kHz, the ratio of the SCSs may be 2 (=30 kHz/15 kHz). In this case, two NR SL slots corresponding to one LTE SL slot may be excluded in the resource selection operation.

[Data Transmission Method Considering AGC Issue in Coexistence Environment Between LTE SL Terminal and NR SL Terminal]

Even in operations other than resource selection operation, a relationship between LTE subframes and NR slots in the time domain may need to be considered according to the SCSs of two RATs. When the NR SCS is 30 kHz and the LTE SCS is 15 kHz, two NR slots may exist within one LTE subframe. A problem may occur in an AGC operation when the AGC operation is performed based on the LTE subframe and receive powers for two NR slots included in the LTE subframe are different from each other.

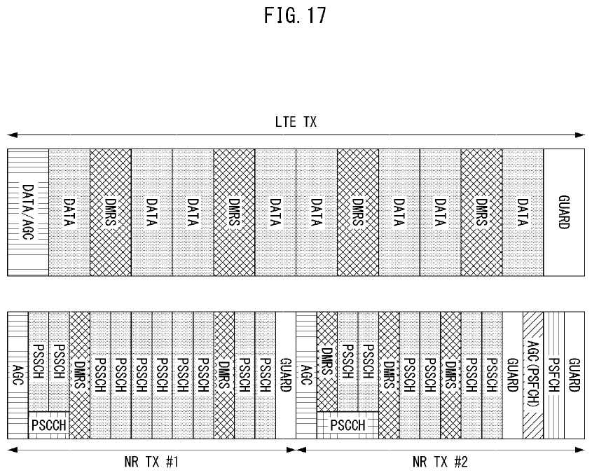

FIG. 17 is a conceptual diagram illustrating a first exemplary embodiment of NR transmission using different transmit powers.

Referring to FIG. 17, the LTE SCS may be 15 kHz and the NR SCS may be 30 kHz. One LTE subframe may include two NR slots. An LTE transmission (i.e., LTE TX) in the LTE subframe and NR transmissions (i.e., NR TX #1 and NR TX #2) in the NR slots may be performed simultaneously. The terminal may perform an AGC operation based on the LTE subframe. If a difference between a transmit power (e.g., receive power) of the NR TX #1 in the first NR slot and a transmit power (e.g., receive power) of the NR TX #2 in the second NR slot is large, degradation of reception performance according to a change in the receive power may occur during reception of the LTE subframe. When one NR slot among the two NR slots is not transmitted or when a PSFCH is transmitted in the NR slot, the degradation of reception performance may be large because a change in the transmit power is large. To solve the above-described problem, the SCS for the NR slots coexisting with the LTE subframe may always be limited to 15 kHz. When the same SCS (e.g., 15 kHz SCS) is applied to the NR slot and the LTE subframe, one NR slot may exist within one LTE subframe. Therefore, the AGC problem according to a change of the receive power in the NR slots may be solved.

Different SCSs may be applied to the NR slot and the LTE subframe. In this case, an NR SL resource used by the NR terminal (e.g., NR SL terminal) for SL transmission may overlap with an LTE SL resource in the time domain, and an NR SL resource used by the NR terminal for SL transmission may not overlap with an LTE SL resource in the frequency domain. In the above-described situation, the terminal may perform SL transmission using NR SL resources in a plurality of NR slots. In order to solve the AGC issue occurring due to a difference between the transmit power of the NR TX #1 and the transmit power of the NR TX #2, omission of transmission in at least one of NR slots, or transmission of a PSFCH in at least one of NR slots, the NR terminal may always perform SL transmission over two slots.

The number Nₛₗₒₜ of NR slots in which SL transmission is continuously performed may be set in consideration of a ratio between the LTE SCS and the NR SCS (e.g., Nₛₗₒₜ=SCS_{NR}/SCS_{LTE}). When an NR SL resource overlaps with an LTE SL resource, the NR terminal may perform SL transmission over Nₛₗₒₜ slots. When an NR SL resource does not overlap with an LTE SL resource, the NR terminal may perform SL transmission in one slot or slots less than Nₛₗₒₜ slots. When SL transmission is performed in consecutive Nₛₗₒₜ slots, an AGC issue may temporarily occur due to guard symbols present in the slots. When SL transmission is performed in consecutive Nₛₗₒₜ slots, it may be preferable to repeat a previous PSSCH transmission in guard symbols present in the slots. When SL transmission is performed in consecutive Nₛₗₒₜ slots, receiving terminals for the consecutive Nₛₗₒₜ slots may be the same or different. The receiving terminals for consecutive Nₛₗₒₜ slots may be determined according to a transmit power when performing the SL transmission. When an SL pathloss-based power control operation is performed, it may be preferable that the receiving terminals for the consecutive Nₛₗₒₜ slots in which SL transmission is performed are the same. When the receiving terminals for the consecutive Nₛₗₒₜ slots are different from each other and a difference in the transmit powers between the slots is large due to the SL pathloss-based power control operation, an AGC issue for the receiving terminal may occur in the LTE subframe corresponding to the slots (e.g., consecutive Nₛₗₒₜ slots).

When the SL pathloss-based power control operation is performed, in order to solve the AGC issue, the transmitting terminal may perform SL transmission to the same receiving terminal in consecutive Nₛₗₒₜ slots. When the SL pathloss-based power control operation is performed and a difference in transmit powers for different terminals is not large, the transmitting terminal may perform SL transmission for different receiving terminals in consecutive Nₛₗₒₜ slots. For example, when a difference between a first transmit power of a first receiving terminal and a second transmit power of a second receiving terminal is less than or equal to a specific value, the transmitting terminal may perform SL transmission for the first receiving terminal and the second receiving terminal in consecutive Nₛₗₒₜ slots. The specific value may be set to the terminal by signaling (e.g., system information signaling, PC5-RRC signaling, UE-specific RRC signaling, MAC CE signaling, control information signaling). The specific value may be set for each resource pool. Alternatively, the terminal may determine the specific value in an implementation manner.

When the transmitting terminal performs a DL pathloss-based power control operation or when the transmitting terminal performs SL transmission using a maximum transmit power without performing a DL pathloss-based (or SL pathloss-based) power control operation, the SL transmission may always be performed using the same transmit power in consecutive Nₛₗₒₜ slots regardless of the receiving terminal. Therefore, the SL transmission may be performed without restrictions on the same receiving terminal.

When SL transmission is performed in consecutive Nₛₗₒₜ slots, it may be preferable that the frequency resource size of each slot is the same in the frequency domain. In each slot, if the receiving terminal, size of transmission data, MCS level, and/or priority are different, the size of the resource required for SL transmission may be different. Accordingly, it may be difficult for consecutive Nₛₗₒₜ slots to have frequency resources of the same size. In this case, data (e.g., SL data) transmitted in the first slot among consecutive Nₛₗₒₜ slots may be repeatedly transmitted in the remaining slot(s) after the first slot. The receiving terminal may know in advance that the data is repeatedly transmitted in consecutive Nₛₗₒₜ slots. In this case, the receiving terminal may repeatedly receive the data in consecutive Nₛₗₒₜ slots, and reception performance can be improved by receiving the repeated data.

If data reception is successful in the first slot among the consecutive Nₛₗₒₜ slots, the receiving terminal may determine whether to receive data repeated in the remaining slot(s) after the first slot in an implementation manner. In order to support the above operation, whether data is repeatedly transmitted in the consecutive Nₛₗₒₜ slots may be signaled to the terminal. For example, information indicating whether data is repeatedly transmitted in the consecutive Nₛₗₒₜ slots may be included in SCI (e.g., first-stage SCI and/or second-stage SCI).

Alternatively, the transmitting terminal may transmit actual data in the first slot among the consecutive Nₛₗₒₜ slots, and may transmit a dummy signal in the remaining slot(s). The receiving terminal may perform a reception operation for the actual data in the first slot among the consecutive Nₛₗₒₜ slots, and may omit a reception operation in the remaining slot(s). To support the above operation, the transmitting terminal may signal information indicating whether to transmit a dummy signal to the receiving terminal. The information indicating whether a dummy signal is transmitted in slots other than the first slot among the consecutive Nₛₗₒₜ slots may be included in SCI (e.g., first-stage SCI and/or second-stage SCI).

The Information indicating whether data is repeatedly transmitted in consecutive Nₛₗₒₜ slots or the information indicating whether a dummy signal is transmitted in slots other than the first slot among consecutive Nₛₗₒₜ slots may be dynamically signaled by SCI. The size of the information indicating whether data is repeatedly transmitted in consecutive Nₛₗₒₜ slots or the information indicating whether a dummy signal is transmitted may be 1 bit. In other words, the information indicating whether data is repeatedly transmitted in consecutive Nₛₗₒₜ slots or the information indicating whether a dummy signal is transmitted may be an indicator having a size of 1 bit, and the indicator may be explicitly signaled by SCI. Alternatively, a specific value of a specific field included in the SCI may implicitly indicate the information indicating whether data is repeatedly transmitted in consecutive Nₛₗₒₜ slots or the information indicating whether a dummy signal is transmitted.

Considering one or more conditions (e.g., transmit power, TB size, MCS level, and/or receiving terminal) for SL transmission in consecutive Nₛₗₒₜ slots, the transmitting terminal may transmit different data to different receiving terminals or the same receiving terminal in the respective slots. Alternatively, the transmitting terminal may repeatedly transmit data to the same receiving terminal in consecutive Nₛₗₒₜ slots. Alternatively, the transmitting terminal may transmit data in some slots (e.g., the first slot) among consecutive Nₛₗₒₜ slots, and may transmit a dummy signal in the remaining slot(s). The receiving terminal may receive the data in the first slot among consecutive Nₛₗₒₜ slots. Thereafter, the receiving terminal may perform a reception operation in consideration of a transmission scheme indicated by the transmitting terminal in the remaining slot(s) other than the first slot among consecutive Nₛₗₒₜ slots. When the same data is repeatedly transmitted in consecutive Nₛₗₒₜ slots and the receiving terminal successfully receives the data in the first slot among the consecutive Nₛₗₒₜ slots, the receiving terminal may omit a reception operation in the remaining slot(s) excluding the first slot among the consecutive Nₛₗₒₜ slots.

When the same data is repeatedly transmitted in consecutive Nₛₗₒₜ slots and the receiving terminal fails to receive the data in the first slot among the consecutive Nₛₗₒₜ slots, the receiving terminal may perform a reception operation for the data in the remaining slot(s) after the first slot among the consecutive Nₛₗₒₜ slots. The receiving terminal may improve reception performance by performing a combining operation on the data received in the slots.

When a dummy signal is transmitted in the remaining slot(s) excluding the first slot among the consecutive Nₛₗₒₜ slots, the receiving terminal may omit a reception operation in the remaining slot(s) excluding the first one among the consecutive Nₛₗₒₜ slots. When data is not repeatedly transmitted in consecutive Nₛₗₒₜ slots or when a dummy signal is not transmitted in the remaining slot(s) excluding the first slot among consecutive Nₛₗₒₜ slots, the receiving terminal may perform a reception operation for the data in the remaining slot(s) after the first slot even after the data is successfully received in the first slot.

Therefore, the information indicating whether data is repeatedly transmitted in consecutive Nₛₗₒₜ slots or the information indicating whether a dummy signal is transmitted in slots other than the first slot among consecutive Nₛₗₒₜ slots may be preferable to be signaled to the terminal by SCI (e.g., 1-bit indicator included in the SCI).

The repeated transmission of data in consecutive Nₛₗₒₜ slots, transmission of different data in consecutive Nₛₗₒₜ slots, or transmission of a dummy signal in some slots among consecutive Nₛₗₒₜ slots may be performed depending on a circumstance. In order to dynamically indicate the transmissions, an indication field having a size of 2 bits or more may be required in the SCI. Alternatively, information indicating whether each of the transmissions is applied may be configured to the terminal by signaling (e.g., system information signaling, PC5-RRC signaling, UE-specific RRC signaling). The information indicating whether each of the transmissions is applied may be configured for each resource pool.

In order to solve the AGC problem between LTE subframes and NR slots, even when NR SL resource(s) corresponding to a transmission timing (e.g., transmission time, transmission duration) of the LTE terminal does not overlap with LTE SL resource(s) of the LTE terminal in the frequency domain, the NR SL resource(s) may be excluded in the NR SL resource selection operation. The NR SL module may receive LTE SL information from the LTE SL module, and perform the NR SL resource selection operation based on the LTE SL information. Even when the NR SL resource(s) corresponding to the transmission timing for the LTE SL resource(s) used by the LTE SL module do not overlap with the LTE SL resource(s) in the frequency domain, the NR SL module may exclude the NR SL Resource(s) in the NR SL resource selection operation. When there are a large number of LTE SL resources (e.g., resources that the LTE terminal intends to use), the NR SL module may not be able to secure enough candidate resources in the NR SL resource selection operation.

When the LTE SCS is 15 kHz and the NR SCS is 30 kHz, one LTE subframe may correspond to two NR slots. When a start time of the first NR slot (e.g., a start time of the first OFDM symbol) of the two NR slots overlaps a start time of the LTE subframe (e.g., a start time of the first OFDM symbol), the AGC problem may not occur even when SL transmission is not performed in the second NR slot. In other words, the AGC operation considering a transmit power (or receive power) for the NR slot may be performed from the start time of the LTE subframe. Accordingly, even when SL transmission is not performed in the second NR slot, the AGC operation may be possible within an allowable range (e.g., dynamic range).

The start time of the LTE subframe may not overlap with the start time of the NR slot. For example, when a resource of the first NR slot is empty, the start time of the LTE subframe may not overlap with the start time of the NR slot. In this case, the AGC operation for the LTE subframe may be performed without considering the transmit power of the NR slot. When SL transmission is performed based on a high transmit power in the second NR slot, the allowable range of the AGC may be exceeded from a start time of the second NR slot. Accordingly, saturation may occur and reception performance may deteriorate. Only when the start time of the LTE subframe does not overlap with the start time of the NR slot (e.g., when the resource of the first NR slot is empty), if the NR SL resource(s) corresponding to the transmission duration for the LTE SL (e.g., LTE SL resource) is excluded from the NR SL candidate resources, the problem of not securing enough NR SL candidate resources can be solved.

Methods (e.g., SL transmission in a plurality of NR slots, exclusion of LTE SL resources, exclusion of NR SL resource(s) corresponding to the transmission duration for the LTE SL (e.g., LTE SL resource)) proposed to solve the AGC problem between LTE subframes and NR slots may be applied differently according to various environments. For example, in an environment where there is not much LTE SL traffic, even when NR SL resources corresponding to the start time for the LTE SL resource are excluded, the transmitting terminal may secure sufficient NR SL candidate resources. The exclusion of the LTE SL resource may mean the exclusion of the NR SL resource(s) corresponding to the transmission duration for the LTE SL (e.g., LTE SL resource). In an environment where it is difficult to exclude LTE SL resources (e.g., NR SL resources overlapping with the LTE SL resources), the transmitting terminal may perform SL transmission in a plurality of NR slots. Alternatively, in the environment where it is difficult to exclude LTE SL resources (e.g., NR SL resources overlapping with LTE SL resources), if a frequency resource of the LTE subframe does not overlap with a frequency resource of the NR slot, SL transmission may be allowed in the NR slot overlapping with the start time of the LTE subframe. According to the above methods, the AGC problem between LTE subframe and NR slots may be solved. Information indicating application of each of the SL transmission operation in a plurality of NR slots and the LTE SL resource exclusion operation may be configured for each resource pool or BWP. The information indicating application of each of the SL transmission operation in a plurality of NR slots and the LTE SL resource exclusion operation may be configured to the terminal through signaling (e.g., system information signaling, UE-specific RRC signaling, PC5-RRC signaling, MAC CE signaling).

[PSFCH Transmission Method Considering AGC Issue in Coexistence Environment Between LTE SL Terminal and NR SL Terminal]

SL transmission may be performed in consecutive Nₛₗₒₜ slots in consideration of the LTE SL SCS and the NR SL SCS. In this case, when there is an NR slot in which a PSFCH resource is configured, an AGC issue may occur due to a difference between a transmit power in the PSFCH resource and a transmit power in a resource (e.g., PSCCH resource and/or PSSCH resource) other than the PSFCH resource and/or a guard symbol between a PSSCH symbol and a PSFCH symbol. When PSFCH resources are not configured in consecutive Nₛₗₒₜ slots, it may be preferable to perform SL transmission in the consecutive Nₛₗₒₜ slots. When a PSFCH resource is configured in an NR slot, a transmission method considering the PSFCH resource may be required.

In the NR SL, a PSFCH may be a channel for transmission of a HARQ-ACK feedback (e.g., ACK or NACK) for a PSSCH. The PSFCH may only exist in an NR slot. In other words, the PSFCH may not exist in an LTE subframe. When an NR slot and an LTE subframe overlap, all symbols within the LTE subframe may be used for data transmission, and some symbols within the NR slot may be configured as a PSFCH symbol and an AGC symbol for the PSFCH. Therefore, it may be preferable to configure resource regions of the two RATs not to overlap in the PSFCH symbol and/or the AGC symbol. As a method of configuring the resource regions of the two RATs not to overlap in a PSFCH resource region, a resource region corresponding to the NR slot in which the PSFCH is transmitted (e.g., NR slot including the PSFCH symbol) may be configured to be used only by the NR terminal. The LTE subframe may also be configured in a resource region corresponding to an NR slot in which the PSFCH is not transmitted, and the resource region (e.g., NR slot or LTE subframe) may be used by both the NR terminal and the LTE terminal. According to the above-described method, overlap between resource regions of the two RATs in the PSFCH resource region may be prevented.

PSFCH slots (e.g., NR slots in which the PSFCH is transmitted) may be configured to have a periodicity of 1, 2, or 4 slots. When the periodicity of the PSFCH slots is 1 slot, all slots may be configured as NR slots. In this case, LTE SL transmission may not be performed. When the LTE SCS and the NR SCS are different, a situation in which it is difficult to configure LTE subframes may occur. For example, when the LTE SCS is 15 kHz, the NR SCS is 30 kHz, and the periodicity of the PSFCH slots is 2 slots, it may be difficult to configure LTE subframes. When NR resources are configured after LTE resources are configured, updating of the LTE resources may be difficult. It may be difficult to configure PSFCH slots only for NR terminals.

As another method for configuring resource regions of the two RATs not to overlap in the PSFCH resource region, a frequency resource region of the PSFCH may be configured not to overlap with a resource region (e.g., frequency resource region) of LTE SL. When the LTE terminal and the NR terminal coexist on the same channel, the frequency resource region of the PSFCH may be configured not to overlap with the resource region of LTE SL. In this case, SL transmission of the LTE terminal may be prevented from overlapping with PSFCH transmission. The frequency resource region of the PSFCH may be configured within a resource pool and may be indicated by a bitmap. Each bit in the bitmap may correspond to n RBs. n may be a natural number. The PSFCH may be configured in a resource region that does not overlap with the resource region of LTE SL.

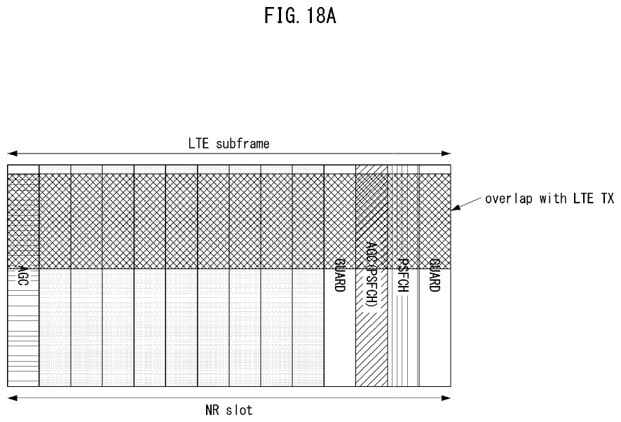

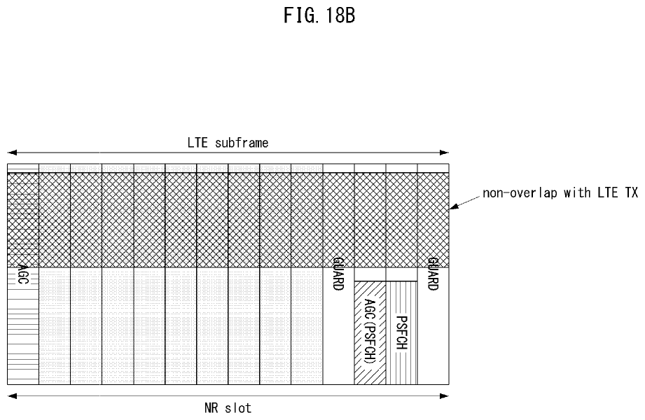

FIG. 18A is a conceptual diagram illustrating a first exemplary embodiment of PSFCH resource allocation, and FIG. 18B is a conceptual diagram illustrating a second exemplary embodiment of PSFCH resource allocation.

Referring to FIG. 18A, a PSFCH resource may overlap an LTE resource. Referring to FIG. 18B, a PSFCH resource may be configured in consideration of an LTE resource, and the PSFCH resource may not overlap with the LTE resource. In an environment where an LTE terminal and an NR terminal coexist on the same channel, the PSFCH resource may be configured not to overlap with the LTE resource as in the exemplary embodiment of FIG. 18B. In this case, a collision between PSFCH transmission and LTE SL transmission may be prevented. Even when the PSFCH resource is configured not to overlap with the LTE resource in the frequency domain, PSFCH transmission may overlap with LTE SL transmission in the time domain. In this case, a transmit power may temporarily increase in a PSFCH transmission period, and an AGC problem may occur in a terminal performing a reception operation in the PSFCH transmission period.

When reception operations for NR SL and LTE SL are simultaneously performed, the transmit power may temporarily increase in the PSFCH transmission period, and the increased transmit power may exceed the allowable (i.e., dynamic) range of the AGC. In this case, reception performance may deteriorate. Performing a power control operation during PSFCH transmission in the environment where the LTE terminal and the NR terminal coexist may be configured. When the terminal exists within a coverage of the network, the existing power control operation for the PSFCH may be configured to be performed based on a DL pathloss (or SL pathloss). When the terminal exists outside the coverage of the network, the PSFCH may be transmitted with a maximum transmit power (e.g., Pmax).

In the environment in which the LTE terminal and the NR terminal coexist on the same channel, operations of the terminal outside the coverage of the network may be usually considered. Therefore, according to the existing technical specification, the PSFCH may always be transmitted with the maximum transmit power. In order to solve the above-described problem, a power control operation based on a DL pathloss (or SL pathloss) may be performed even outside the coverage of the network. Alternatively, it may be preferable to set the maximum transmit power to a value smaller than the existing value.

As another method for solving the problem of co-channel coexistence between LTE terminal and NR terminal for the PSFCH slot, a HARQ-ACK feedback function of the NR terminal communicating on the same channel with the LTE terminal may be disabled. In other words, it may be configured so that PSFCH transmission does not occur. In the NR SL, unicast communication and groupcast communication may support the HARQ-ACK feedback function. The HARQ-ACK feedback function may be enabled or disabled. When resources for PSFCH transmission are not configured in a resource pool, it may be determined that the HARQ-ACK feedback function is disabled in the resource pool. When resources for PSFCH transmission are configured in a resource pool, the transmitting terminal may transmit second-stage SCI including information indicating enabling or disabling of the HARQ-ACK feedback function.

When the LTE terminal and the NR terminal coexist on the same channel, the PSFCH resources may not be configured in the resource pool so that PSFCH transmission does not occur. When the LTE terminal and the NR terminal coexist on the same channel, PSFCH resources are configured in the resource pool, and it is determined that LTE SL transmission occurs in a PSFCH slot, the NR terminal may transmit information indicative of disabling the HARQ-ACK feedback function. Alternatively, when it is determined that LTE SL transmission occurs in a PSFCH slot (e.g., PSFCH symbol) in which a HARQ-ACK feedback for data transmitted in a specific slot is transmitted, the NR terminal (e.g., transmitting terminal) may transmit data in slots excluding the specific slot. When it is determined that LTE SL transmission occurs in a PSFCH slot (e.g., PSFCH symbol) in which a HARQ-ACK feedback for data is transmitted, the NR terminal (e.g., receiving terminal) may drop transmission of the HARQ-ACK feedback.

When the PSFCH transmission is dropped, the transmitting terminal may not be able to receive the HARQ-ACK feedback for the data from the receiving terminal. In the HARQ ACK/NACK feedback scheme for unicast, the transmitting terminal may determine that the HARQ-ACK feedback has not been received as NACK, and perform retransmission of the data. In the HARQ ACK/NACK feedback option 2 for groupcast, the transmitting terminal may determine that the HARQ-ACK feedback has not been received as NACK, and perform retransmission of the data. When the PSFCH transmission dropped by the receiving terminal is ACK, resources may be wasted due to the retransmission of the data, but a problem in data transmission/reception may not occur.

In the HARQ ACK/NACK feedback option 1 (e.g., NACK-only feedback scheme) for groupcast, ACK may not be transmitted when data reception is successful, and NACK may be transmitted when data reception fails. When the HARQ ACK/NACK feedback option 1 for groupcast is used, a problem may occur in data transmission/reception. For example, when the receiving terminal fails to receive the data, the HARQ-ACK feedback may be NACK. In this case, if the receiving terminal drops the PSFCH transmission due to a collision with the LTE SL transmission, the transmitting terminal may determine that the receiving terminal has successfully received the data. Accordingly, the transmitting terminal may not retransmit the data.

In order to solve the above problem, when the PSFCH transmission is predicted to be dropped due to overlap between the PSFCH transmission and the LTE SL transmission, the transmitting terminal may transmit information indicative of disabling of the HARQ-ACK feedback function to the receiving terminal, and retransmit the data regardless of whether the data has been received at the receiving terminal. In the data retransmission procedure, the HARQ-ACK feedback function may be continuously disabled, and the transmitting terminal may retransmit the data a predefined number of times. Alternatively, when PSFCH transmission becomes possible, the transmitting terminal may transmit information indicative of enabling of the HARQ-ACK feedback function to the receiving terminal, and then retransmit the data. The transmitting terminal may receive a HARQ-ACK feedback for the retransmitted data from the receiving terminal, and based on the HARQ-ACK feedback, the transmitting terminal may determine whether to perform a data retransmission procedure.

The above-described methods (e.g., methods for preventing a collision between PSFCH transmission and LTE SL transmission) may be applied to all NR SL transmissions. Alternatively, the above-described methods may be applied only to some NR transmissions according to condition(s). The above-described methods may include a method of selecting a slot in which data is transmitted considering a collision between PSFCH transmission and LTE SL transmission and/or a method of dropping PSFCH transmission considering a collision between PSFCH transmission and LTE SL transmission. The above-described methods may not be applied to PSFCH transmissions satisfying specific condition(s). For example, the specific condition(s) may include a case when NR SL transmission with a high priority is performed, a case when a PSFCH resource overlaps an LTE SL resource with a low RSRP, and/or a case when a PSCCH and/or PSSCH having the same transmit power as that of a PSFCH is transmitted in a time period overlapping with a PSFCH slot. The specific condition(s) may be configured to the terminal by signaling (e.g., system information signaling, UE-specific RRC signaling, PC5-RRC signaling, MAC CE signaling, control information signaling).

When PSFCH transmission is performed based on the existing procedure in the NR SL, the PSFCH slot of the NR SL may be excluded from the resource sensing operation of the LTE terminal. Unlike the resource sensing operation of the NR terminal, the LTE terminal may perform the selection operation of candidate resources based on SCI and/or RSRP measurement, and may select a final candidate resource based on RSSI(s) of the candidate resource(s) selected by the selection operation. In other words, the LTE terminal may perform the first resource selection operation for selecting the candidate resources and the second resource selection operation for selecting the final candidate resource. In the resource selection operation(s), the LTE terminal may preferentially select a resource having a low RSSI as the final candidate resource. An RSSI for a resource in which a PSFCH is transmitted (e.g., PSFCH resource) may be measured to be relatively high. Accordingly, the LTE terminal may exclude the PSFCH resource from the candidate resources (e.g., final candidate resource) in the resource selection operation(s).

In order to increase a probability of being excluded in the RSSI-based resource selection operation, some slots among SL resources may be configured as basic slots (e.g., basic PSFCH slots or basic resource set). It may be preferable to perform PSCCH transmission and/or PSFCH transmission including PSSCH in the basic slot. It may be preferable that a resource for transmission of data associated with a HARQ-ACK feedback is selected in the resource selection operation of the NR terminal so that the HARQ-ACK feedback is transmitted in the basic slot (e.g., basic PSFCH slot). PSFCH slot(s) other than the basic PSFCH slot may be configured, and the HARQ-ACK feedback may be transmitted in the PSFCH slot(s). In this case, an AGC issue may occur in the LTE terminal (e.g., LTE SL terminal), and a resource collision between the NR terminal and the LTE terminal may occur. It may be preferable for the resource selection operation of the NR terminal to be operated so that PSFCH transmission occurs in the basic PSFCH slot.

When PSFCH transmissions increase in the NR terminal, resources for the PSFCH transmissions may be increased through additional configuration of the basic PSFCH slots. Performing of the RSSI measurement operation on the added basic PSFCH slots may not initially be excluded in the LTE terminal. In other words, the added basic PSFCH slots may not be excluded in the resource selection operation of the LTE terminal. An average RSSI may increase over time, and a probability of excluding the added basic PSFCH slots in the resource selection operation may gradually increase.

The LTE terminal supporting only periodic data transmission may perform the RSSI measurement operation according to a reservation periodicity of data resources. For example, the LTE terminal may perform the RSSI measurement operation according to a periodicity of ms, 50 ms, or 100 ms. It may be preferable for the basic PSFCH slots to be configured in consideration of the periodicity of the RSSI measurement operation of the LTE terminal. Considering all reservation periodicities of data resources in the LTE terminal, the periodicity of the RSSI measurement operation may be set to a periodicity of 10 ms (e.g., the greatest common divisor of all reservation periodicities) or 100 ms (e.g., the least common multiple of all reservation periodicities). The NR terminal may perform PSFCH transmission using the maximum transmit power so that an RSSI for the PSFCH transmission is measured high. In other words, PSFCH transmission using the maximum transmit power may be configured in the terminal. The PSFCH transmission may be operated in an implementation manner. Alternatively, the PSFCH transmission may be predefined in the technical specification.

In order to solve the co-channel coexistence problem between LTE terminal and NR terminal in the PSFCH slot, the NR transmitting terminal may preferentially select a resource for transmission of data so that a PSFCH resource for a HARQ-ACK feedback for the data does not overlap with an SL resource of the LTE terminal. In this case, the efficiency of resource selection may decrease. When the NR transmitting terminal disables the HARQ-ACK feedback function or when the NR receiving terminal drops PSFCH transmission, reliability of SL communication may deteriorate and unnecessary retransmission operations may be performed.

When the LTE terminal excludes the PSFCH resource (e.g., basic PSFCH slot) of the NR terminal from the candidate resources (e.g., final candidate resource) based on the RSSI, if there is a high data traffic in the channel, exclusion of the PSFCH resource from the candidate resources may not be guaranteed. Since the resource exclusion operation based on RSSI measurement is performed on candidate resources selected based on SCI and RSRP measurement, the selected final candidate resources may not be sufficient for transmission. In addition, wrong final candidate resources may be selected. It may be preferable that the method in which the NR transmitting terminal selects a resource for transmission of data so that a PSFCH resource for a HARQ-ACK feedback for the data does not overlap with an SL resource of the LTE terminal, the method in which the NR transmitting terminal disables the HARQ-ACK feedback function, the method in which the NR receiving terminal drops PSFCH transmission, and/or the method in which the LTE terminal excludes a PSFCH resource of the NR terminal from candidate resources (e.g., final candidate resources) based on RSSI measurement is used appropriately according to a situation.

In a general situation or a situation with high data traffic in the channel, at least one of the method in which the NR transmitting terminal selects a resource for transmission of data so that a PSFCH resource for a HARQ-ACK feedback for the data does not overlap with an SL resource of the LTE terminal, the method in which the NR transmitting terminal disables the HARQ-ACK feedback function, or the method in which the NR receiving terminal drops PSFCH transmission may be applied. In a situation where a ratio of LTE terminals in the channel is low, the method in which the LTE terminal excludes a PSFCH resource of the NR terminal from candidate resources (e.g., final candidate resources) based on RSSI measurement may be applied. Information on method(s) to be applied may be configured to the terminal by signaling (e.g., system information signaling, UE-specific RRC signaling, PC5-RRC signaling, MAC CE signaling, control information signaling). The method(s) to be applied may be configured for each resource pool. The terminal may determine the method(s) to be applied based on whether the data transmission/reception operation is successful and/or the result of the resource sensing operation, and may transmit SCI (e.g., first-stage SCI and/or second-stage SCI) including information indicating the method(s) to be applied.

[Configuration Method of a Timeline for Using LTE SL Information]

One terminal may include an LTE SL module and an NR SL module. A time when sensing information (e.g., a result of a resource sensing operation) of the LTE SL module is delivered to the NR SL module may be before a time when a resource selection operation of the NR SL module is performed. The sensing information of the LTE SL module may be referred to as ‘LTE sensing information’ or ‘LTE sensing result’. If the time when the LTE sensing information is delivered is too early than the time when the resource selection operation of the NR SL module is performed, the LTE sensing information may be outdated information at the time of performing the resource selection operation of the NR SL module. It may be preferable to appropriately set the time when the LTE sensing information is delivered.

Referring to FIG. 13, the NR SL resource selection operation may be triggered at a time n. In this case, the LTE sensing information required for the NR SL resource sensing operation may be delivered at the time n or a time before n. In order to prevent the LTE sensing information from becoming invalid information, it may be necessary to limit the time before n. For example, it may be preferable for the LTE sensing information to be transmitted between a time n−Tₛ₁ and the time n. Tₛ₁ may be predefined as a fixed value. Alternatively, Tₛ₁ may be configured to the terminal by signaling (e.g., system information signaling, UE-specific RRC signaling, PC5-RRC signaling, MAC CE signaling, control information signaling). Tₛ₁ may be the same as T_{proc,0} of FIG. 13. If the LTE sensing information is transmitted before Tₛ₁ (e.g., T_{proc,0}), the LTE sensing information may be determined as invalid information, and the LTE sensing information may be ignored.

The LTE sensing information may be delivered at the time n or after the time n. In this case, it may be necessary to limit the time after the time n so that as much the LTE sensing information is considered as possible in the resource selection operation. For example, it may be preferable for the LTE sensing information to be transmitted between the time n and a time n+Tₛ₂. Tₛ₂ may be predefined as a fixed value. Alternatively, Tₛ₂ may be configured to the terminal by signaling (e.g., system information signaling, UE-specific RRC signaling, PC5-RRC signaling, MAC CE signaling, control information signaling). Tₛ₂ may be the same as T₁ in FIG. 13. Alternatively, the LTE sensing information may be delivered between a time (e.g., Tₛ₁) before the time n and a time (e.g., Tₛ₂) after the time n. When the LTE SCS and the NR SCS are different, Tₛ₁ and Tₛ₂ may be set based on the NR SCS.

The time when the LTE sensing information of the LTE SL module is delivered to the NR SL module within one terminal may be prior to the time when the resource selection operation of the NR SL module is performed. Considering a processing time of the resource selection operation of the NR SL module, it may be preferable to appropriately set the time when the LTE sensing information is delivered. As in the exemplary embodiment of FIG. 13, when the NR SL resource selection operation is triggered at the time n, the LTE sensing information required for the NR SL resource selection operation may be delivered at a time before the time n. Considering a processing time of the NR SL module, it may be preferable to deliver the LTE sensing information at a time n−Tₛ₃ which is a time prior to the time n. Tₛ₃ may be predefined as a fixed value. Alternatively, Tₛ₃ may be configured to the terminal by signaling (e.g., system information signaling, UE-specific RRC signaling, PC5-RRC signaling, MAC CE signaling, control information signaling). Tₛ₃ may be limited within a time (e.g., 4 ms) for exchanging priority information for the modules in coexistence between the LTE SL module and the NR SL module included in the same terminal. In other words, the terminal may determine Tₛ₃ as a value within 4 ms in an implementation manner.

Even in the above-described exemplary embodiment, in order to prevent the LTE sensing information from becoming invalid information, it may be necessary to appropriately set the time when the LTE sensing information is delivered. Only LTE sensing information delivered at or after a time n−Tₛ₄ may be determined as valid information. LTE sensing information delivered at or after the time n−Tₛ₄ may be utilized in the NR SL resource selection operation. To may be predefined as a fixed value in consideration of a sensing window of the LTE module and/or resource reservation periodicities supported by the LTE SL. Alternatively, Tₛ₄ may be configured to the terminal by signaling (e.g., system information signaling, UE-specific RRC signaling, PC5-RRC signaling, MAC CE signaling, control information signaling). If Tₛ₄ is not configured, the terminal may determine Tₛ₄ in an implementation manner. When the LTE SCS and the NR SCS are different, it may be preferable for Tₛ₃ and Tₛ₄ to be configured based on the NR SCS.

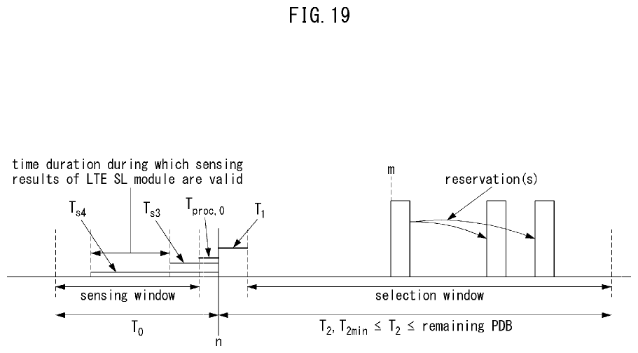

FIG. 19 is a conceptual diagram illustrating a first exemplary embodiment of a timeline for delivering LTE sensing information to an NR SL module.

Referring to FIG. 19, the NR SL module may determine LTE sensing information received between the time n−Tₛ₄ and the time n−Tₛ₃ as valid information, and may perform the resource selection operation in consideration of the LTE sensing information. Tₛ₃ may be preferably set as T_{proc,0}<Tₛ₃≤4 ms. Tₛ₄ may be preferably set as 0<Tₛ₄≤4 ms. Tₛ₄ may be set to an appropriate time before Tₛ₃. Tₛ₄ may be set within the sensing window. For example, Tₛ₄ may be at or after a time n−T₀ within the sensing window. Alternatively, Tₛ₄ may be set before the sensing window (e.g., n−T₀). When Tₛ₃ and/or Tₛ₄ are not configured, the terminal may determine Tₛ₃ and/or Tₛ₄ in an implementation manner. The LTE sensing information may be delivered to the NR SL module according to a request of the NR SL module or a specific condition. In this case, Tₛ₄ may be set after a request time of the NR SL module or a time when the specific condition is satisfied.

[Resource Selection Operation Using Inter-UE Coordination (IUC) Information]

In NR SL, an IUC function may be supported. In this case, a first terminal may transmit information on preferred resources and/or non-preferred resources to a second terminal. The second terminal may perform a resource selection operation in consideration of the preferred resources and/or the non-preferred resources. The preferred resources may refer to preferred candidate resources and/or a preferred resource set. The non-preferred resources may refer to non-preferred candidate resources and/or a non-preferred resource set. When a resource collision between the terminals is predicted, the first terminal may transmit collision prediction information (e.g., collision resource information) to the second terminal. The collision prediction information may be transmitted to a terminal in which a collision is predicted through a PSFCH (e.g., PSFCH for CI). A method to be used among the method of transmitting information on preferred resources/non-preferred resources and the method of transmitting collision prediction information may be preconfigured. The information on preferred resources/non-preferred resources may refer to at least one of information on preferred resources and information on non-preferred resources.

The IUC function may be used to improve reliability between NR terminals. Alternatively, the IUC function may be applied for co-channel coexistence between LTE terminal and NR terminal. When the method of transmitting information on preferred resources/non-preferred resources is used, a terminal including an LTE SL module and an NR SL module may generate at least one of a preferred resource list or a non-preferred resource list based on a result of an LTE SL resource sensing operation (e.g., LTE sensing information) and a result of an NR SL resource sensing operation (e.g., NR sensing information). In other words, the first terminal may generate the preferred resource list and/or the non-preferred resource list by considering the NR sensing information as well as the LTE sensing information, and may transmit the preferred resource list and/or the non-preferred resource list to the second terminal. The second terminal may perform a resource selection operation in consideration of the preferred resource list and/or the non-preferred resource list. LTE resources and NR resources may not be distinguished in each of the preferred resource list and the non-preferred resource list. The preferred resource list may refer to information on preferred resources, and the non-preferred resource list may refer to information on non-preferred resources.

A message (e.g., MAC CE and/or SCI) including the information on preferred resources and/or the information on non-preferred resources may be received by the NR terminal. Therefore, it may be preferable to transmit the message including the information on preferred resources and/or the information on non-preferred resources to the NR terminal. The information on preferred resources and/or the information on non-preferred resources may be utilized in a resource selection operation of some NR terminals not capable of performing an LTE SL resource sensing operation in the co-channel coexistence environment between LTE terminal and NR terminal.

When the method of transmitting collision prediction information is used, a terminal including an LTE SL module and an NR SL module may predict a resource collision between an LTE terminal and a NR terminal as well as a resource collision between NR terminals. In this case, the terminal may transmit collision prediction information through a PSFCH (e.g., PSFCH for CI). The collision prediction information may include NR collision prediction information and LTE/NR collision prediction information. The NR collision prediction information may be prediction information on a resource collision between NR terminals. The LTE/NR collision prediction information may be prediction information on a resource collision between an LTE terminal and an NR terminal.

A legacy LTE terminal may not be able to utilize the collision prediction information. Therefore, it may be preferable to transmit the collision prediction information to the NR terminal. In the co-channel coexistence environment between LTE terminal and NR terminal, the collision prediction information may be utilized in a resource selection operation of some NR terminals not capable of performing an LTE SL resource sensing operation. Even when a resource collision between LTE terminals is predicted, since the LTE terminal is not able to utilize the collision prediction information, it may be preferable that prediction information on a resource collision between LTE terminals is not transmitted to the LTE terminal.

[Method for Time Synchronization Between LTE Terminal and NR Terminal]

For the co-channel coexistence between LTE terminal and NR terminal, it may be necessary for LTE SL resources and NR SL resources to be well aligned in time and/or frequency domain. If the resources are not aligned between two RATs, performance may be degraded due to interference in a resource sensing operation, a resource selection operation, and/or a transmission operation. For alignment of the resources of the two RATs, accurate synchronization acquisition may be necessary. It may be important that synchronization is acquired based on the same synchronization reference (or source).

Depending on a configuration and/or circumstance in SL communication, the synchronization reference may be a global navigation satellite system (GNSS), base station, and/or another terminal. An NR terminal may synchronize with an NR base station (e.g., gNB) and/or an LTE base station (e.g., eNB). An LTE terminal may synchronize only with an LTE base station (e.g., eNB). When the synchronization reference is another terminal, the NR terminal may synchronize with another NR terminal and/or another LTE terminal. The LTE terminal may synchronize only with another LTE terminal.

According to a synchronization source selection criterion, a priority of an LTE communication node (e.g., LTE base station or LTE terminal) may be higher than that of an NR communication node (e.g., NR base station or NR terminal). In this case, since the LTE terminal and the NR terminal acquire synchronization through the same synchronization source, a problem may not occur. When a priority of an NR communication node (e.g., NR base station or NR terminal) is higher than that of an LTE communication node (e.g., LTE base station or LTE terminal), the NR terminal may select a synchronization source having a higher priority but the LTE terminal may not select the synchronization source having a higher priority. In this case, synchronization between the two RATs (e.g., NR terminal and LTE terminal) may not be accurately matched. Therefore, the performance of resource sharing may be degraded.

To solve the above problem, the NR terminal may transmit an LTE SL synchronization signal to the LTE terminal. When the priority of the NR communication node (e.g., NR base station or NR terminal) is higher than that of the LTE communication node (e.g., LTE base station or LTE terminal), the NR terminal may acquire synchronization with an NR base station and/or another NR terminal, and may transmit the LTE SL synchronization signal to the LTE terminal based on the acquired synchronization. The LTE terminal may receive the LTE SL synchronization signal from the NR terminal and may acquire synchronization based on the LTE SL synchronization signal. In this case, the NR terminal and the LTE terminal may operate based on the same synchronization.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first terminal supporting a first radio access technology (RAT) and a second RAT, the method comprising:
determining candidate resources by performing a resource sensing operation based on the first RAT;
performing a resource selection operation based on the first RAT with respect to the candidate resources in consideration of information on resources of the second RAT; and
performing sidelink (SL) communication based on the first RAT with a second terminal using resources selected by the resource selection operation based on the first RAT.

2. The method according to claim 1, wherein when resource sharing between the first RAT and the second RAT is configured, the information on the resources of the second RAT is shared for the resource selection operation based on the first RAT, the first RAT is a new radio (NR) communication technology, and the second RAT is a long term evolution (LTE) communication technology.

3. The method according to claim 1, wherein the information on the resources of the second RAT indicates one or more resources reserved by a third terminal supporting the second RAT, and at least one candidate resource overlapping with the one or more reserved resources among the candidate resources is excluded in the resource selection operation based on the first RAT.

4. The method according to claim 1, wherein when the information on the resources of the second RAT indicates one or more resources reserved by a third terminal supporting the second RAT, and a reference signal received power (RSRP) of at least one reserved resource among the one or more reserved resources is greater than or equal to an RSRP threshold, at least one candidate resource overlapping with the at least one reserved resource among the candidate resources is excluded in the resource selection operation based on the first RAT.

5. The method according to claim 1, wherein the information on the resources of the second RAT includes at least one of information on a time resource reserved by a third terminal, information on a frequency resource reserved by the third terminal, information on a periodicity of a resource reserved by the third terminal, information on an RSRP for the reserved resource, information on a priority of data of the third terminal, or combinations thereof.

6. The method according to claim 4, wherein the RSRP threshold is configured by system information, PC5-radio resource control (RRC) signaling, or user equipment (UE)-specific RRC signaling.

7. The method according to claim 1, wherein when a first subcarrier spacing (SCS) applied to the first RAT is different from a second SCS applied to the second RAT, the selected resources include all slots overlapping duration corresponding to SL transmission based on the second RAT, and SL communication based on the first RAT is continuously performed over the all slots.

8. The method according to claim 1, wherein when a first subcarrier spacing (SCS) applied to the first RAT is different from a second SCS applied to the second RAT, the selected resources include a first slot overlapping duration corresponding to SL transmission based on the second RAT, and SL communication based on the first RAT is allowed in the first slot.

9. The method according to claim 1, wherein when physical sidelink feedback channel (PSFCH) transmission based on the first RAT overlaps SL transmission based on the second RAT in SL transmission based on the first RAT, which is performed between the first terminal and the second terminal, the PSFCH transmission based on the first RAT is dropped or disabled.

10. The method according to claim 1, wherein the performing of the resource selection operation based on the first RAT comprises: when PSFCH transmission based on the first RAT overlaps SL transmission based on the second RAT, excluding at least one candidate resource for transmission of a physical sidelink shared channel (PSSCH) associated with the PSFCH transmission based on the first RAT among the candidate resources.

11. A first terminal supporting a first radio access technology (RAT) and a second RAT, comprising a processor, wherein the processor causes the first terminal to perform:
determining candidate resources by performing a resource sensing operation based on the first RAT;
performing a resource selection operation based on the first RAT with respect to the candidate resources in consideration of information on resources of the second RAT; and
performing sidelink (SL) communication based on the first RAT with a second terminal using resources selected by the resource selection operation based on the first RAT.

12. The first terminal according to claim 11, wherein when resource sharing between the first RAT and the second RAT is configured, the information on the resources of the second RAT is shared for the resource selection operation based on the first RAT, the first RAT is a new radio (NR) communication technology, and the second RAT is a long term evolution (LTE) communication technology.

13. The first terminal according to claim 11, wherein the information on the resources of the second RAT indicates one or more resources reserved by a third terminal supporting the second RAT, and at least one candidate resource overlapping with the one or more reserved resources among the candidate resources is excluded in the resource selection operation based on the first RAT.

14. The first terminal according to claim 11, wherein when the information on the resources of the second RAT indicates one or more resources reserved by a third terminal supporting the second RAT, and a reference signal received power (RSRP) of at least one reserved resource among the one or more reserved resources is greater than or equal to an RSRP threshold, at least one candidate resource overlapping with the at least one reserved resource among the candidate resources is excluded in the resource selection operation based on the first RAT.

15. The first terminal according to claim 11, wherein the information on the resources of the second RAT includes at least one of information on a time resource reserved by a third terminal, information on a frequency resource reserved by the third terminal, information on a periodicity of a resource reserved by the third terminal, information on an RSRP for the reserved resource, information on a priority of data of the third terminal, or combinations thereof.

16. The first terminal according to claim 14, wherein the RSRP threshold is configured by system information, PC5-radio resource control (RRC) signaling, or user equipment (UE)-specific RRC signaling.

17. The first terminal according to claim 11, wherein when a first subcarrier spacing (SCS) applied to the first RAT is different from a second SCS applied to the second RAT, the selected resources include all slots overlapping duration corresponding to SL transmission based on the second RAT, and SL communication based on the first RAT is continuously performed over the all slots.

18. The first terminal according to claim 11, wherein when a first subcarrier spacing (SCS) applied to the first RAT is different from a second SCS applied to the second RAT, the selected resources include a first slot overlapping duration corresponding to SL transmission based on the second RAT, and SL communication based on the first RAT is allowed in the first slot.

19. The first terminal according to claim 11, wherein when physical sidelink feedback channel (PSFCH) transmission based on the first RAT overlaps SL transmission based on the second RAT in SL transmission based on the first RAT, which is performed between the first terminal and the second terminal, the PSFCH transmission based on the first RAT is dropped or disabled.

20. The first terminal according to claim 11, wherein in the performing of the resource selection operation based on the first RAT, the processor further causes the first terminal to perform: when PSFCH transmission based on the first RAT overlaps SL transmission based on the second RAT, excluding at least one candidate resource for transmission of a physical sidelink shared channel (PSSCH) associated with the PSFCH transmission based on the first RAT among the candidate resources.
